(19) United States
(12) Patent Application Publication
(10) Pub. No.: US 2023/0297459 A1
(43) Pub. Date: Sep. 21, 2023

(54) COMPUTER-READABLE RECORDING MEDIUM STORING ANALYSIS PROGRAM, ANALYSIS METHOD, AND INFORMATION PROCESSING SYSTEM

(71) Applicant: Fujitsu Limited, Kawasaki-shi (JP)

(72) Inventor: Yuta OIKAWA, Kawasaki (JP)

(73) Assignee: Fujitsu Limited, Kawasaki-shi (JP)

(21) Appl. No.: 18/156,428

(22) Filed: Jan. 19, 2023

(30) Foreign Application Priority Data
Mar. 17, 2022 (JP) 2022-042116

(51) Int. Cl. G06F 11/07

(52) U.S. Cl. CPC G06F 11/079; G06F 11/0781; G06F 11/0712

(57) ABSTRACT

A recording medium stores a program for causing a computer to execute a process including: calculating a deviation degree between a first measurement value which represents an execution state in a period in which the problem does not occur and a second measurement value which represents the execution state in a period in which the problem occurs; calculating an involvement degree which indicates a degree of relevance to the problem based on a relationship between an occurrence location of the problem and each software element; calculating a single influence point which indicates a degree influenced by the problem based on the deviation degree and the involvement degree; and calculating a total influence point which indicates a degree to which a first software element is influenced by the problem, based on a single influence point of the first software element and a single influence point of a second software element.

### CROSS-REFERENCE TO RELATED APPLICATION

This application is based upon and claims the benefit of priority of the prior Japanese Patent Application No. 2022-42116, filed on Mar. 17, 2022, the entire contents of which are incorporated herein by reference.

### FIELD

The embodiments discussed herein are related to a non-transitory computer-readable recording medium storing an analysis program, an analysis method, and an information processing system.

### BACKGROUND

In a case where a certain problem occurs in a computer system, in order to continuously operate the system, it is desirable to accurately grasp a range of an influence caused by the problem that occurs. On the other hand, in a system using a container, which is a virtual execution environment for software, a system configuration tends to be complicated due to characteristics of the system. Meanwhile, a configuration such as an arrangement of the containers frequently is changed. Therefore, it is increasingly difficult to accurately grasp the range of the influence caused by the problem.

Japanese Laid-open Patent Publication No. 2020-005138, Japanese Laid-open Patent Publication No. 2021-072548, and Japanese Laid-open Patent Publication No. 2002-328893 are disclosed as related art.

### SUMMARY

According to an aspect of the embodiments, a non-transitory computer-readable recording medium stores an analysis program for causing a computer to execute a process including: calculating, when a problem occurs in a monitoring target system, a deviation degree between a first measurement value which represents an execution state of a process in a period in which the problem does not occur and a second measurement value which represents the execution state of the process in a period in which the problem occurs, for each of a plurality of software elements executed in the monitoring target system; calculating an involvement degree which indicates a degree of relevance to the problem, for each of the plurality of software elements, based on a relationship over a system configuration between an occurrence location of the problem and each of the plurality of software elements; calculating a single influence point which indicates a degree of being individually influenced by the problem, for each of the plurality of software elements, based on the deviation degree and the involvement degree; and calculating a total influence point which indicates a degree to which a first software element is influenced by the problem, based on a single influence point of the first software element and a single influence point of a second software element over a communication path of communication via a process by the first software element.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an analysis method according to a first embodiment;

FIG. 2 is a diagram illustrating an example of a system configuration according to a second embodiment;

FIG. 3 is a diagram illustrating an example of hardware of an analysis apparatus;

FIG. 4 is a block diagram illustrating an example of a function of the analysis apparatus;

FIG. 5 is a diagram illustrating an example of information passed to analyze an influence range of a problem;

FIG. 6 is a diagram illustrating an example of configuration information;

FIG. 7 is a diagram illustrating an example of a relationship between elements across a layer;

FIG. 8 is a diagram illustrating an example of communication path information;

FIG. 9 is a diagram illustrating an example of a horizontal configuration relationship;

FIG. 10 is a diagram illustrating an example of a configuration of an operation management system;

FIG. 11 is a diagram illustrating an example of candidate element specification based on a vertical configuration relationship;

FIG. 12 is a diagram illustrating an example of candidate element specification based on the horizontal configuration relationship;

FIG. 13 is a diagram illustrating an example of a normal-time metric;

FIG. 14 is a flowchart illustrating an example of a procedure of an influence point calculation process;

FIG. 15 is a flowchart illustrating an example of a procedure of a deviation degree calculation process;

FIG. 16 is a diagram illustrating an example of a normal-time statistical index table;

FIG. 17 is a flowchart illustrating an example of a procedure of an involvement degree calculation process;

FIG. 18 is a flowchart illustrating an example of a procedure of a single influence point calculation process;

FIG. 19 is a flowchart illustrating an example of a procedure of a total influence point calculation process;

FIG. 20 is a diagram illustrating an example of a specification result of a candidate element of an influence location;

FIG. 21 is a diagram illustrating an example of a calculation result of a deviation degree;

FIG. 22 is a diagram illustrating an example of a calculation result of an involvement degree;

FIG. 23 is a diagram illustrating an example of a calculation result of a single influence point;

FIG. 24 is a diagram illustrating an example of a calculation result of a total influence point;

FIG. 25 is a diagram illustrating an example of an influence range screen;

FIG. 26 is a diagram illustrating an example of a calculation result of the involvement degree in a case where a problem occurrence location is a workload; and

FIG. 27 is a diagram illustrating an example of a calculation result of the involvement degree in a case where the problem occurrence location is Pod.

### DESCRIPTION OF EMBODIMENTS

As a technology related to grasping of the influence of the problem of the system, for example, a failure cause inference method is proposed in which it is unnecessary to calculate all failure propagation paths in advance and it is possible to automatically narrow down failure causes. A network management apparatus capable of appropriately executing an evaluation on a terminal that may be influenced when a configuration of a network is changed is also proposed. A damage evaluation system related to network security is also proposed, which enables quick and objective evaluation over a wide range.

According to a method in the related art, for example, a range related to a location at which a problem occurs is determined from configuration information of a system and communication path information when the problem occurs, and the corresponding range is set as an influence range. In this case, for example, it is determined that a problem occurring in a node (hardware or a virtual machine (VM)) affects all containers operating in the node and software (SW) elements executed in the container.

For example, it is determined that the influence of the problem also affects the SW element that transmits a process request to the SW element influenced by the problem. In this manner, when the influence range is determined only by the system configuration information and the communication path information, the influence range becomes too wide, and accuracy of whether or not an element included in the influence range is actually influenced is decreased. For example, even an element that does not actually have an influence or has a minor influence and does not have an immediate response may be included in the influence range. As a result, there is a delay in addressing the SW element that is to quickly address the problem that occurs.

According to one aspect, an object of the present disclosure is to improve accuracy of determination of a software element included in an influence range.

Hereinafter, the present embodiments will be described with reference to the drawings. Each embodiment may be implemented by combining a plurality of embodiments within a range without contradiction.

### First Embodiment

A first embodiment is an analysis method for an operation state of a system to be monitored, for improving accuracy of determination of a software (SW) element included in an influence range.

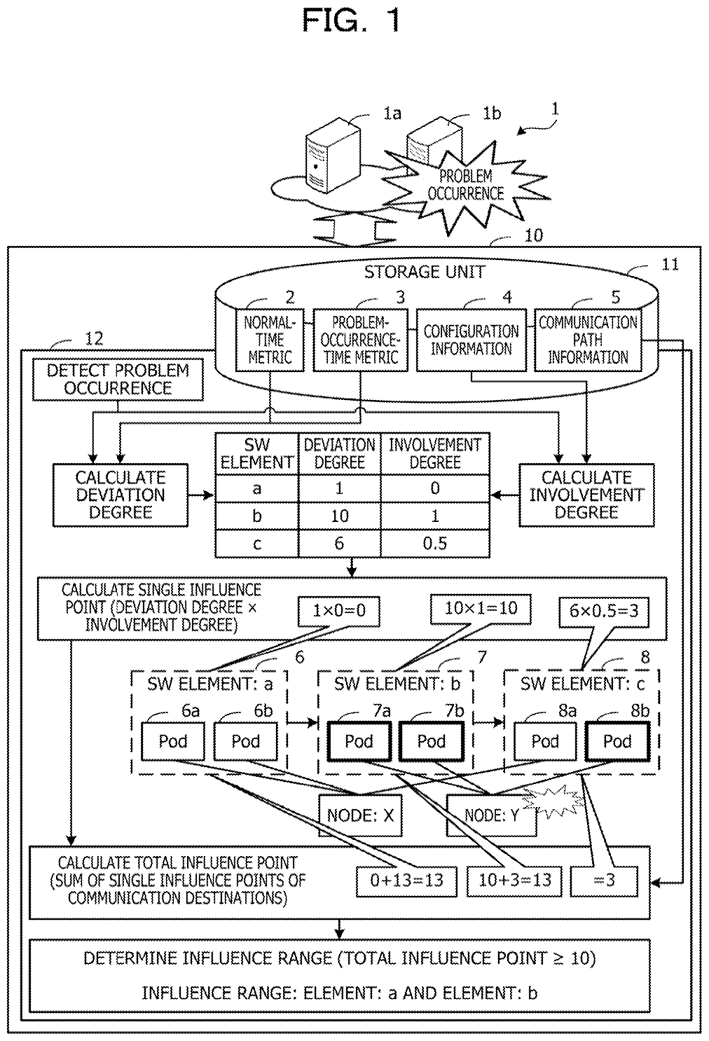

FIG. 1 is a diagram illustrating an example of the analysis method according to the first embodiment. FIG. 1 illustrates an information processing system 10 for implementing the analysis method according to the first embodiment. For example, the information processing system 10 may implement the analysis method according to the first embodiment, by executing a predetermined analysis program.

The information processing system 10 includes a storage unit 11 and a processing unit 12. For example, the storage unit 11 is a memory or a storage device included in the information processing system 10. For example, the processing unit 12 is a processor or an arithmetic circuit included in the information processing system 10. The information processing system 10 is configured with, for example, a computer that monitors a monitoring target system 1 and a computer that analyzes an influence range of a problem that occurs based on a monitoring result. The information processing system 10 may be a single computer that monitors the monitoring target system 1 and analyzes the influence range of the problem based on the monitoring result.

In a case where a problem occurs in the monitoring target system 1, the information processing system 10 analyzes an influence range of the problem. The monitoring target system 1 includes, for example, a plurality of nodes 1a and 1b. Each of the nodes 1a and 1b is, for example, a computer (physical machine) or a virtual machine. A plurality of SW elements 6 to 8 for providing a service are operated in the plurality of nodes 1a and 1b. The SW elements 6 to 8 are, for example, application software (hereinafter, referred to as app) called a workload. The SW elements 6 to 8 are executed in, for example, a container that is a virtual execution environment of the app. One or a plurality of containers implemented by the same node are managed in a management unit (collection of containers) called Pod, for example.

For example, the SW element 6 is executed in each container of the plurality of Pods 6a and 6b. The SW element 7 is executed in each container of the plurality of Pods 7a and 7b. The SW element 8 is executed in each container of the plurality of Pods 8a and 8b.

The storage unit 11 of the information processing system 10 stores information to be used for analysis. For example, the storage unit 11 stores a normal-time metric 2, a problem-occurrence-time metric 3, configuration information 4, and communication path information 5.

The normal-time metric 2 is a value (first measurement value) of a predetermined index representing an execution state of a process, which is measured while the monitoring target system 1 operates normally. For example, the normal-time metric 2 indicates a measurement result of a process execution time at a normal time.

The problem-occurrence-time metric 3 is a value (second measurement value) of a predetermined index representing an execution state of a process, which is measured while a problem occurs in the monitoring target system 1. For example, the problem-occurrence-time metric 3 indicates a measurement result of a process execution time while the problem occurs.

The configuration information 4 indicates a hierarchical structure of an execution environment of an app implemented in the monitoring target system 1. For example, the configuration information 4 includes information on a node in the lowest layer, information on an execution resource (including a container and a Pod) which is an upper layer of the node, and information on the SW elements 6 to 8 which is an upper layer of the execution resource. The configuration information 4 indicates a relationship between the node, the execution resource, and the SW elements 6 to 8. For example, the configuration information 4 indicates information indicating which Pod a container executing the SW elements 6 to 8 is included in and over which node the container operates. A configuration relationship indicated in the configuration information 4 in this manner may be referred to as a vertical configuration relationship across the layer.

The communication path information 5 is information indicating a communication path of a process request in the SW elements 6 to 8. In the example illustrated in FIG. 1, the process request transmitted from the SW element 6 is received by the SW element 7. The SW element 7 executes a process corresponding to the received process request, and transmits the process request to the SW element 8. The SW element 8 performs a process in accordance with the process request from the SW element 7. The SW element 8 transmits a process result to the SW element 7. By using the process result acquired from the SW element 8, the SW element 7 completes the process in accordance with the process request from the SW element 6, and transmits a process result to the SW element 6. The SW element 6 completes the own process by using the process result from the SW element 7. In this case, a series of communication paths in which a communication destination of the SW element 6 is the SW element 7 and a communication destination of the SW element 7 is the SW element 8 is obtained. The SW element 6 is a starting end of a communication path, and the SW element 8 is an end of the communication path. Such a relationship indicated in the communication path information 5 may be referred to as a horizontal configuration relationship between the SW elements 6 to 8.

The processing unit 12 detects occurrence of a problem in the monitoring target system 1. For example, the processing unit 12 may monitor an operation of the monitoring target system 1, and detect the problem occurrence by, for example, detecting an abnormal value of a metric or the like.

Upon detecting the occurrence of the problem in the monitoring target system 1, the processing unit 12 calculates, for each of the plurality of SW elements 6 to 8, a deviation degree between a first measurement value and a second measurement value related to a predetermined index representing an execution state of a process. The first measurement value is a value in a period during which a problem indicated by the normal-time metric 2 does not occur. The second measurement value is a value in a period during which the problem indicated by the problem-occurrence-time metric 3 occurs. For example, in a case where the problem-occurrence-time metric 3 is not acquired at a time of the problem detection, the processing unit 12 acquires the problem-occurrence-time metric 3 from the monitoring target system 1 and calculates the deviation degree.

Based on a relationship over a system configuration between a problem occurrence location and each of the plurality of SW elements 6 to 8, the processing unit 12 calculates, for each of the plurality of SW elements 6 to 8, an involvement degree indicating a degree of relevance to the problem. For example, in a case where a problem occurs in any node (hereinafter, referred to as a first node), the processing unit 12 sets an involvement degree of an SW element operating over the first node to be higher than an involvement degree of an SW element not operating over the first node. One SW element is executed in a plurality of virtual execution environments (for example, containers), in some cases. In this case, for example, the processing unit 12 calculates an involvement degree of a target software element of which the involvement degree is to be calculated, based on a ratio of a software execution environment operating over a node which is an occurrence location of a problem to virtual software execution environments at which the target software element is executed. In a case where a container of executing a specific SW element is managed in units of Pod, the processing unit 12 may grasp the ratio of a container operating over the node, which is the occurrence location of the problem, based on a ratio of Pod operating over the node at which the problem occurs.

After the calculation of the deviation degree and the involvement degree of each of the plurality of SW elements 6 to 8 is ended, the processing unit 12 calculates a single influence point indicating a degree of being individually influenced by the problem, for each of the plurality of SW elements 6 to 8, based on the deviation degree and the involvement degree. For example, the processing unit 12 sets a multiplication result of the deviation degree and the involvement degree for each of the plurality of SW elements 6 to 8 as the single influence point of the corresponding SW element.

The processing unit 12 calculates a total influence point indicating a degree of a total influence received from the problem, for each of the plurality of SW elements 6 to 8, by adding a mutual influence between the SW elements 6 to 8. A calculation target of the total influence point is a first SW element. At this time, the processing unit 12 calculates a total influence point indicating a degree to which the first SW element is influenced by the problem, based on the single influence point of the first SW element and a single influence point of a second SW element over a communication path of communication via the first SW element. The communication path may be determined based on the communication path information 5. For example, the processing unit 12 sets an SW element which is a transmission destination of a process request in the communication path of the process request via the first SW element, as the second SW element. For example, the processing unit 12 sets a sum of the single influence point of the first SW element and the single influence point of the second SW element as the total influence point.

In a case where the total influence point of the first SW element is equal to or more than a predetermined value, the processing unit 12 determines that the first SW element is within an influence range of the problem that occurs. The total influence point is a highly reliable value obtained by using the deviation degree between the normal-time metric 2 and the problem-occurrence-time metric 3, the involvement degree based on the vertical configuration relationship indicated in the configuration information 4, and the horizontal configuration relationship indicated in the communication path information 5. Therefore, by determining whether or not each SW element is within the influence range of the problem based on the total influence point, it is possible to obtain a determination result with high accuracy.

For example, with the vertical configuration relationship, it is possible to obtain an influence range over a configuration caused by a problem, and with the horizontal configuration relationship, it is possible to obtain a range and a degree of an influence actually exerted on another element over the system by the problem that occurs. As a result, it is possible to grasp in detail the influence range with high priority based on a magnitude of the influence that is actually occurring, and it is possible to shorten a restoration and handling time.

For example, in the example illustrated in FIG. 1, the problem occurs in the node 1b. At this time, it is assumed that the deviation degree of the SW element 6 is “1”, the deviation degree of the SW element 7 is “10”, and the deviation degree of the SW element 8 is “6”. The SW element 6 is executed in Pods 6a and 6b operating in the node 1a, and the involvement degree is “0”. The SW element 7 is executed in Pods 7a and 7b operating in the node 1b, and the involvement degree is “1”. The SW element 8 is executed in Pod 8a operating in the node 1a and in Pod 8b operating in the node 1b, and the involvement degree is “0.5”.

It is assumed that a single influence point is “deviation degree×involvement degree”, the single influence point of the SW element 6 is “0”. The single influence point of the SW element 7 is “10”. The single influence point of the SW element 8 is “3”.

The total influence point of each of the plurality of SW elements 6 to 8 is set as a sum of the single influence points (including a single influence point of the SW element itself) of communication destinations (to an end of the communication path). The total influence point of the SW element 6 is “13”. The total influence point of the SW element 7 is “13”. The total influence point of the SW element 8 is “3”. When a threshold value of the total influence point for determining that the total influence point is within the influence range is set to “10”, the SW element 6 and the SW element 7 are determined as influence elements influenced by the problem.

In a case of the example illustrated in FIG. 1, regarding the SW element 7, both of the plurality of Pods 7a and 7b at which the SW element 7 is executed operate in the node 1b of the problem occurrence location, and there is a high possibility that the SW element 7 is influenced. For example, accuracy of the determination result indicating that the SW element 7 is an influence element is high. The SW element 6 transmits a process request to the SW element 7. When the process in the SW element 7 is delayed due to the influence of the problem, the influence of the delay affects the SW element 6. Therefore, the accuracy of the determination result indicating that the SW element 7 is an influence element is high.

On the other hand, regarding the SW element 8, among two Pods 8a and 8b at which the SW element 8 is executed, one is operating in the node 1b at which the problem occurs, and the other is operating in the other node 1a. In a case where Pods 8a and 8b have a redundant configuration, even when the process by the execution of the SW element 8 by Pod 8b is delayed, there is a possibility that the process delay as a whole may be small due to the execution of the SW element 8 by other Pod 8a. The SW element 8 is an end of the communication path, and does not transmit a process request to another SW element and wait for a process result. Therefore, it is highly likely that the influence of the problem that occurs on the SW element 8 is minor, and accuracy of the determination result indicating that the SW element 8 is out of the influence range is high.

Although the example in which the problem occurs in the node 1b is illustrated in the example illustrated in FIG. 1, the problem occurrence location may be any SW, in some cases. In this case, the process of calculating an involvement degree is different from the case where the problem occurs in the node 1b. In a case where the problem occurs in any of the SW elements, the processing unit 12 sets the involvement degree of the SW element which is the occurrence location of the problem to be higher than the involvement degree of the SW element which is not the occurrence location of the problem. For example, the processing unit 12 sets the involvement degree of the SW element at the location at which the problem occurs to “1”, and sets the involvement degree of the other SW elements to “0”. Therefore, even in a case where a problem occurs in the SW element, it is possible to determine an influence range of the problem with high accuracy.

In some cases, a problem occurrence location may be any Pod (management unit of containers). In this case, the process of calculating an involvement degree is different from the case where the problem occurs in the node 1b. For example, among a plurality of management units that manage a virtual software execution environment at which a target software element of which an involvement degree is to be calculated is executed, the processing unit 12 calculates the involvement degree of the target software element based on a ratio of a management unit that is a location at which a problem occurs. Therefore, even in a case where a problem occurs in Pod, it is possible to determine an influence range of the problem with high accuracy.

Although only one communication path is illustrated in the example in FIG. 1, various communications along different communication paths are performed in the monitoring target system 1. In this case, the processing unit 12 may calculate a total influence point for each communication path for each of the plurality of SW elements 6 to 8, for example. For example, the processing unit 12 calculates a deviation degree for each communication path for each of the plurality of SW elements 6 to 8. The processing unit 12 calculates a single influence point for each communication path for each of the plurality of SW elements. The processing unit 12 calculates a total influence point for each communication path for each of the plurality of SW elements.

By calculating the total influence point for each communication path in this manner, it is possible to determine an influence range of the problem with high accuracy even in a case where there are a large number of communication paths in the monitoring target system 1.

### Second Embodiment

A second embodiment is a computer system that causes a monitoring apparatus to detect a problem occurring in an operation system that operates a service by using a container, and causes an analysis apparatus to analyze an influence range of the detected problem.

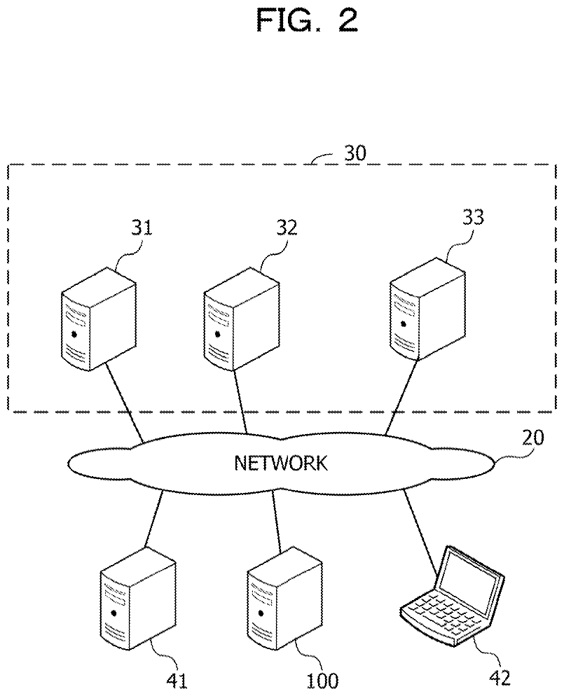

FIG. 2 is a diagram illustrating an example of a system configuration according to the second embodiment. An operation system 30 includes a plurality of nodes 31 to 33. Each of the plurality of nodes 31 to 33 is a computer or a VM that provides a service to a user by using a container. The plurality of nodes 31 to 33 are coupled to a network 20. A monitoring apparatus 41, an analysis apparatus 100, and an operation terminal 42 are further coupled to the network 20.

The monitoring apparatus 41 is a computer that monitors an operation status of each of the plurality of nodes 31 to 33 in the operation system 30. In a case where a problem occurs in any node, a container in the node, or an app, the monitoring apparatus 41 detects the occurrence of the problem. For example, the monitoring apparatus 41 determines that the problem occurs in a case where a time taken for a process is equal to or longer than a predetermined reference value.

The analysis apparatus 100 is a computer that analyzes a range of an influence of the problem that occurs. The analysis apparatus 100 acquires information such as a problem occurrence location from the monitoring apparatus 41, and analyzes the influence range of the problem based on the acquired information.

The operation terminal 42 is a computer used by an operator of the operation system 30. In a case where the problem occurs, the operator may check the influence range of the problem by using the operation terminal 42.

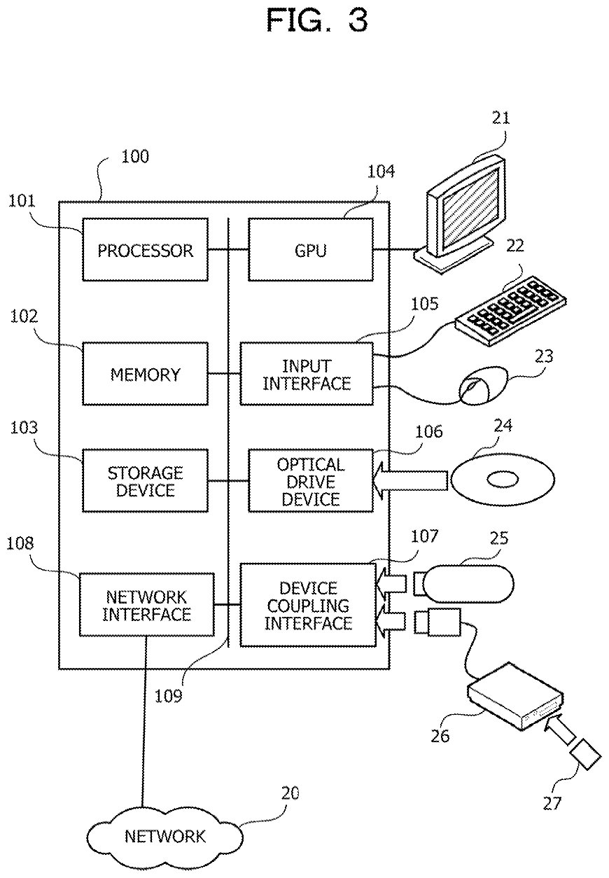

FIG. 3 is a diagram illustrating an example of hardware of an analysis apparatus. The analysis apparatus 100 is entirely controlled by a processor 101. A memory 102 and a plurality of peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least a part of a function realized by the processor 101 executing a program may be implemented by an electronic circuit such as an application-specific integrated circuit (ASIC), a programmable logic device (PLD), or the like.

The memory 102 is used as a main storage device of the analysis apparatus 100. The memory 102 temporarily stores at least a part of an operating system (OS) program or an application program to be executed by the processor 101. The memory 102 stores various types of data to be used for a process by the processor 101. As the memory 102, for example, a volatile semiconductor memory device such as a random-access memory (RAM) or the like is used.

The peripheral device coupled to the bus 109 includes a storage device 103, a graphics processing unit (GPU) 104, an input interface 105, an optical drive device 106, a device coupling interface 107, and a network interface 108.

The storage device 103 writes and reads data electrically or magnetically to a built-in recording medium. The storage device 103 is used as an auxiliary storage device of the analysis apparatus 100. The storage device 103 stores an OS program, an application program, and various types of data. As the storage device 103, for example, a hard disk drive (HDD) or a solid-state drive (SSD) may be used.

The GPU 104 is an arithmetic device that performs an image process, and is also referred to as a graphic controller. A monitor 21 is coupled to the GPU 104. The GPU 104 displays images on a screen of the monitor 21 in accordance with an instruction from the processor 101. As the monitor 21, a display device, a liquid crystal display device, or the like using organic electro luminescence (EL) is used.

A keyboard 22 and a mouse 23 are coupled to the input interface 105. The input interface 105 transmits to the processor 101 signals transmitted from the keyboard 22 and the mouse 23. The mouse 23 is an example of a pointing device, and other pointing devices may be used. An example of the other pointing device includes a touch panel, a tablet, a touch pad, a track ball, or the like.

The optical drive device 106 reads data recorded in an optical disc 24 or writes data to the optical disc 24 by using laser light or the like. The optical disc 24 is a portable recording medium in which data is recorded such that the data is readable by reflection of light. Examples of the optical disc 24 include a Digital Versatile Disc (DVD), a DVD-RAM, a compact disc read-only memory (CD-ROM), a CD-recordable (CD-R), a CD-rewritable (CD-RW), and the like.

The device coupling interface 107 is a communication interface for coupling the peripheral device to the analysis apparatus 100. For example, a memory device 25 and a memory reader and writer 26 may be coupled to the device coupling interface 107. The memory device 25 is a recording medium in which the function of communication with the device coupling interface 107 is provided. The memory reader and writer 26 is a device that writes data to a memory card 27 or reads data from the memory card 27. The memory card 27 is a card-type recording medium.

The network interface 108 is coupled to the network 20. The network interface 108 transmits and receives data to and from another computer or a communication device via the network 20. The network interface 108 is, for example, a wired communication interface that is coupled to a wired communication device such as a switch or a router by a cable. The network interface 108 may be a wireless communication interface that is coupled, by radio waves, to and communicates with a wireless communication device such as a base station or an access point.

The analysis apparatus 100 may be implemented with the hardware configuration as described above. The plurality of nodes 31 to 33, the monitoring apparatus 41, and the operation terminal 42 may be implemented with the same hardware as the analysis apparatus 100. The information processing system 10 described in the first embodiment may also be implemented with the same hardware as the analysis apparatus 100.

The analysis apparatus 100 implements a process function in the second embodiment by, for example, executing a program recorded on a computer-readable recording medium. The program in which process contents to be executed by the analysis apparatus 100 are described may be recorded on various recording media. For example, the program to be executed by the analysis apparatus 100 may be stored in the storage device 103. The processor 101 loads at least a part of the program in the storage device 103 to the memory 102, and executes the program. Furthermore, the program to be executed by the analysis apparatus 100 may be recorded on a portable-type recording medium such as the optical disc 24, the memory device 25, or the memory card 27. The program stored in the portable-type recording medium may be executed after the program is installed in the storage device 103 under the control of the processor 101, for example. The processor 101 may read the program directly from the portable-type recording medium and execute the program.

The analysis apparatus 100 specifies an influence range of a problem with high accuracy by using, in addition to configuration information of the system and communication path information, a deviation degree of metrics at a normal time and a problem occurrence time for each workload of Kubernetes (registered trademark). The workload is an app executed in a container. By executing the workload in the container, a service corresponding to the workload is provided. The workload is an example of the SW element indicated in the first embodiment.

Usefulness of specifying the influence range of the problem by using the deviation degree of the metrics at the normal time and the problem occurrence time will be described. In a case of not using the deviation degree of the metric, the influence range of the problem is determined from the configuration information of the system and the communication path information. In this case, for example, a workload reached when an upper structure is traced from a lower structure over the configuration of the system, from an occurrence location (node, workload, or Pod) of the problem is included in the influence range. A workload having the workload in the influence range as a request destination for communication is also included in the influence range.

As in the case where the influence range of the problem is specified only from the configuration information of the system and the communication path information in this manner, when all workloads reached by tracing the communication path are included in the influence range, the influence range may become enormous. When the influence range becomes enormous, it takes time to handle the problem. Even another workload that transmits a process request to the influenced workload is hardly influenced by the problem, in some cases. For example, communication and an app are redundant, and even when a problem occurs over one communication path, there is a possibility that a process may be continued without being influenced by the problem, by using another communication path having a redundant configuration. In this manner, when an influence range of the problem is specified only from the configuration information of the system and the communication path information, accuracy that the workload within the influence range is influenced by the problem is decreased.

Accordingly, with the analysis apparatus 100 of the system according to the second embodiment, the accuracy that the workload within the influence range is influenced by the problem is improved, by using the deviation degree between the metrics at the normal time and at the problem occurrence time. For example, a workload having a large deviation degree between metrics at a normal time and a problem occurrence time is considered to be greatly influenced by a problem that occurs. A workload operating over a node at which a problem occurs is related to the problem, and is considered to be influenced by the problem. Accordingly, the analysis apparatus 100 represents a degree of the influence by an influence point, based on the involvement degree and the deviation degree in the problem, and includes a workload having the influence point equal to or more than a predetermined value in an influence range. Therefore, it is possible to present the influence range including only the workload influenced by the problem to the operator with high accuracy.

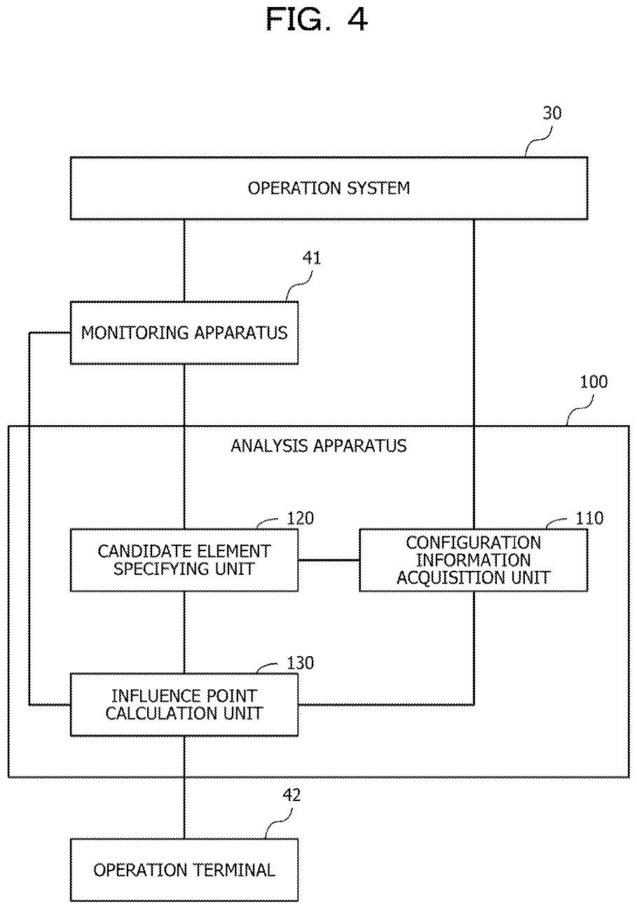

FIG. 4 is a block diagram illustrating an example of a function of an analysis apparatus. The analysis apparatus 100 includes a configuration information acquisition unit 110, a candidate element specifying unit 120, and an influence point calculation unit 130.

The configuration information acquisition unit 110 acquires configuration information of a system and communication path information from the operation system 30. The configuration information acquisition unit 110 transmits the acquired configuration information and communication path information to the candidate element specifying unit 120 and the influence point calculation unit 130.

The candidate element specifying unit 120 specifies a candidate element that may be influenced by a problem that occurs. For example, the candidate element specifying unit 120 traces the configuration information of the system from a location at which the problem occurs to a higher level, and sets a reachable workload as the candidate element. The candidate element specifying unit 120 traces the communication path passing through the workload serving as the candidate element in a transmission source direction of a process request, and adds a reachable workload to the candidate element. The candidate element specifying unit 120 notifies the influence point calculation unit 130 of the specified candidate element.

The influence point calculation unit 130 acquires a normal-time metric and a problem-occurrence-time metric for each candidate element from the monitoring apparatus 41. For each candidate element, the influence point calculation unit 130 calculates a deviation degree between the normal-time metric and the problem-occurrence-time metric. Based on a relationship between the problem occurrence location and the candidate element indicated in the configuration information of the system, the influence point calculation unit 130 calculates an involvement degree of each candidate element to the problem. For each candidate element, the influence point calculation unit 130 calculates an influence point, based on the deviation degree and the involvement degree of the candidate element and other candidate elements over the same communication path as the candidate element. The influence point calculation unit 130 determines a candidate element having an influence point equal to or more than a predetermined threshold value as an influence element influenced by the problem (an element within an influence range). The influence point calculation unit 130 transmits information indicating the element within the influence range to the operation terminal 42.

The function of the configuration information acquisition unit 110, the candidate element specifying unit 120, and the influence point calculation unit 130 may be implemented, for example, by causing a computer to execute a program module corresponding to the function.

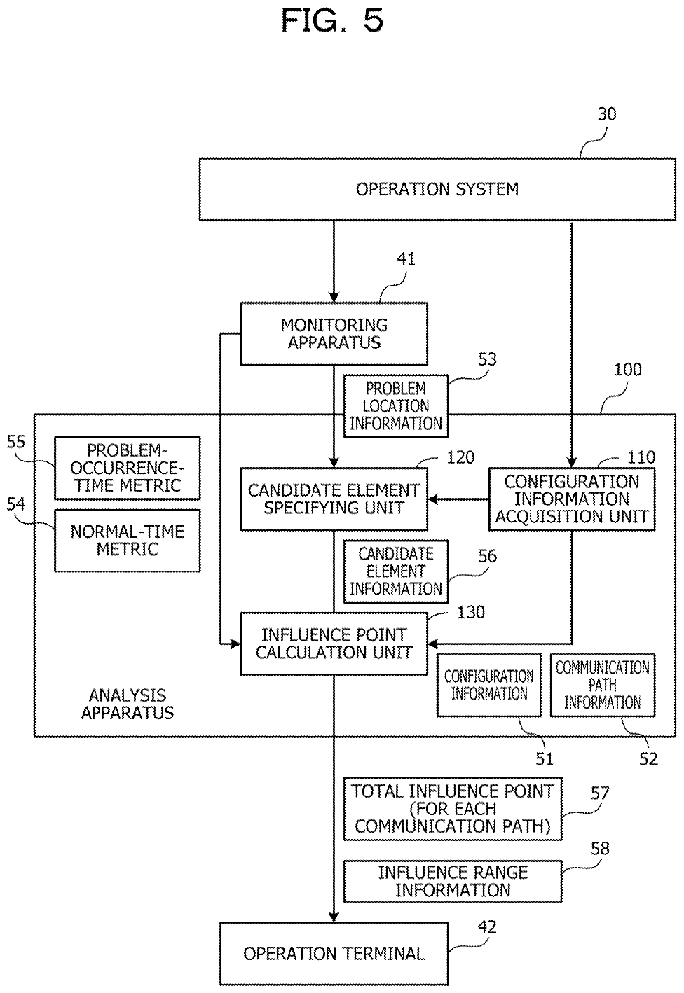

FIG. 5 is a diagram illustrating an example of information passed to analyze an influence range of a problem. For example, the configuration information acquisition unit 110 of the analysis apparatus 100 acquires the configuration information 51 and the communication path information 52 from the operation system 30. The configuration information acquisition unit 110 transmits the acquired configuration information 51 and communication path information 52 to the candidate element specifying unit 120 and the influence point calculation unit 130.

In a case of detecting a problem in the operation system 30, the monitoring apparatus 41 notifies the candidate element specifying unit 120 of problem location information 53 indicating an element at which the problem occurs. The monitoring apparatus 41 transmits a normal-time metric 54 and a problem-occurrence-time metric 55 to the influence point calculation unit 130. The candidate element specifying unit 120 transmits candidate element information 56 indicating the candidate element specified based on the configuration information 51, the communication path information 52, and the problem location information 53 to the influence point calculation unit 130.

Based on each of the acquired information, the influence point calculation unit 130 calculates a total influence point 57 for each candidate element and each communication path. The influence point calculation unit 130 transmits the total influence point 57 and influence range information 58 indicating the influence range of the problem to the operation terminal 42.

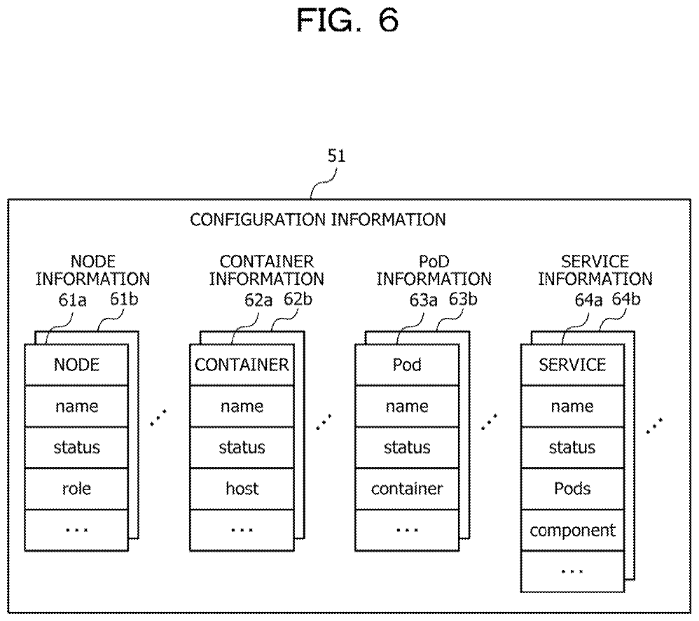

FIG. 6 is a diagram illustrating an example of configuration information. The configuration information 51 includes node information 61a, 61b, . . . for each of the nodes 31 to 33, container information 62a, 62b, . . . for each container in the nodes 31 to 33, Pod information 63a, 63b, . . . for each Pod in the container, and service information 64a, 64b, . . . for each workload executed in Pod.

The node information 61a, 61b, and . . . includes information such as a name, a status, and a role of a corresponding node. The container information 62a, 62b, . . . includes a name and a status of a corresponding container, a name (host) of a node (host) in which the container is executed, and the like. The Pod information 63a, 63b, . . . includes a name and a status of corresponding Pod, a name (container) of a container having the Pod, and the like. The service information 64a, 64b, . . . includes a name and a status of a corresponding service, names (Pods) of one or more Pods executing a workload that provides the service, a name (component) of a software component used to provide the service, and the like.

Based on the configuration information 51, it is possible to grasp a relationship (vertical configuration relationship) across a layer of each element in the operation system 30. The layer may be divided into, for example, a node, an execution resource, and a service.

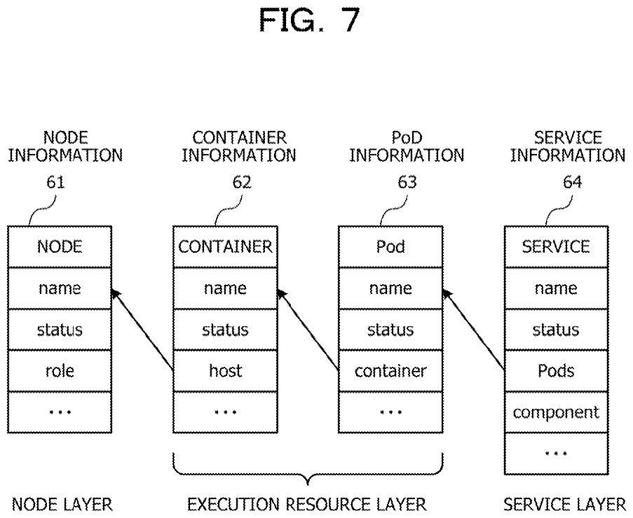

FIG. 7 is a diagram illustrating an example of a relationship between elements across layers. In a case where a hierarchy is divided into a node, an execution resource, and a service, a node layer is indicated by node information 61, an execution resource layer is indicated by container information 62 and Pod information 63, and a service layer is indicated by service information 64.

With a name of Pod set in the service information 64 of a certain service, it is possible to specify Pod at which one or each of a plurality of workloads for providing the service is executed. With a name (container) of a container set in the Pod information 63, it is possible to specify the container having the Pod. With a name (host) of a node (host) set in the container information 62, it is possible to specify the node at which the container is executed.

It is possible to grasp a relationship between the elements across the layers based on the configuration information 51 in this manner. A relationship between elements belonging to the same layer may be grasped based on the communication path information 52.

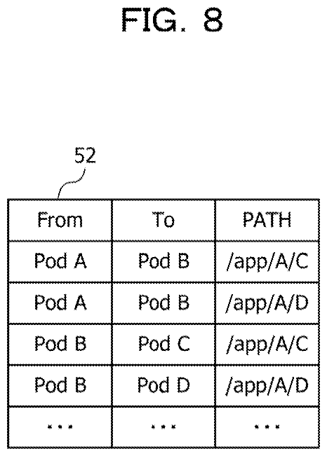

FIG. 8 is a diagram illustrating an example of communication path information. For example, in the communication path information 52, a communication source (From), a communication destination (To), and a path are set for each communication between Pods. The communication source (From) is information indicating Pod that transmits a process request. The communication destination (To) is information indicating Pod that receives the process request. The path is information indicating a communication path used for transmission of the process request. For example, a communication path “/app/A/C” indicates a communication path between apps from “Pod A” to “Pod C”.

Although data in a first line and data in a second line of the communication path information 52 have the same set of a communication source and a communication destination in the example illustrated in FIG. 8, the data in the first line and the data in the second line have communication using different communication paths. Although the data in the first line and data in a third line of the communication path information 52 have the different sets of the communication source and the communication destination, the data in the first line and the data in the third line have communication using the same communication path. With the data in the first line and the data in the third line, a communication path “/app/A/C” is a communication path of “Pod A”→“Pod B”→“Pod C”.

A configuration relationship that may be grasped from such communication path information 52 is referred to as a horizontal configuration relationship. With the horizontal configuration relationship, a relationship between Pods becomes clear.

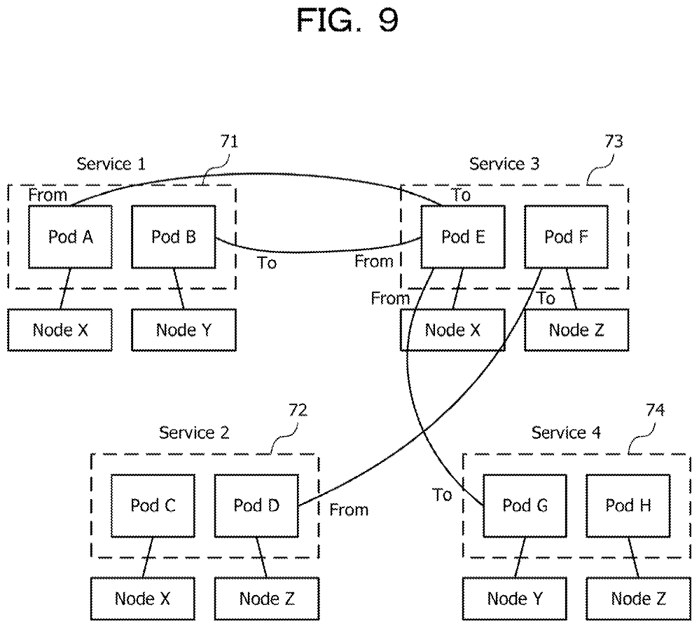

FIG. 9 is a diagram illustrating an example of a horizontal configuration relationship. FIG. 9 illustrates workloads 71 to 74 respectively corresponding to four services. The workload 71 is an app that provides a service “Service 1”. The workload 71 includes an app executed in Pod “Pod A” operating over a node “Node X” and an app executed in Pod “Pod B” operating over a node “Node Y”.

The workload 72 is an app that provides a service “Service 2”. The workload 72 includes an app executed in Pod “Pod C” operating over the node “Node X” and an app executed in Pod “Pod D” operating over a node “Node Z”.

The workload 73 is an app that provides a service “Service 3”. The workload 73 includes an app executed in Pod “Pod E” operating over the node “Node X” and an app executed in Pod “Pod F” operating over the node “Node Z”.

The workload 74 is an app that provides a service “Service 4”. The workload 74 includes an app executed in Pod “Pod G” operating over the node “Node Y” and an app executed in Pod “Pod H” operating over the node “Node Z”.

For example, in a case where communication of the communication source “Pod A” and the communication destination “Pod E” is registered in the communication path information 52, it may be understood that the communication from “Pod A” to “Pod E” in the workload 71 is performed. In the same manner, it is possible to grasp the communication between Pods in each workload, in accordance with the communication between Pods set in the communication path information 52. A relationship of the communication between Pods in each workload is a horizontal configuration relationship.

By combining the vertical configuration relationship indicated in the configuration information 51 and the horizontal configuration relationship indicated in the communication path information 52 in the analysis apparatus 100, it is possible to grasp a range in which influence propagation of a problem is possible when the problem occurs.

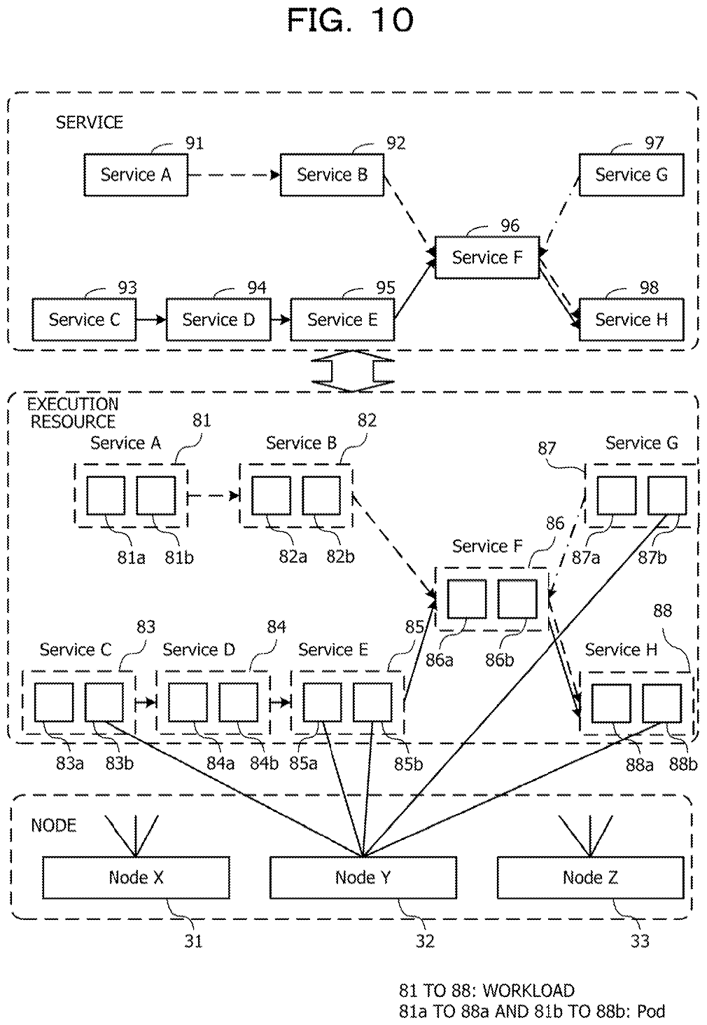

FIG. 10 is a diagram illustrating an example of a configuration of an operation management system. A plurality of services 91 to 98 are provided by corresponding workloads 81 to 88, respectively. FIG. 10 illustrates that a service name of each service is described over a workload corresponding to the service.

The workload 81 is executed in Pods 81a and 81b. The workload 82 is executed in Pods 82a and 82b. The workload 83 is executed in Pods 83a and 83b. The workload 84 is executed by Pods 84a and 84b. The workload 85 is executed by Pods 85a and 85b. The workload 86 is executed by Pods 86a and 86b. The workload 87 is executed by Pods 87a and 87b. The workload 88 is executed by Pods 88a and 88b.

Each of Pods 81a to 88a and 81b to 88b is operated by any one of the plurality of nodes 31 to 33. A vertical configuration relationship between a node and Pod is represented by an edge (line) across layers. For example, five Pods 83b, 85a, 85b, 87b, and 88b are operated in the node 32. FIG. 10 does not illustrate an edge indicating a vertical configuration relationship between nodes other than the node 32 and Pod.

In the example illustrated in FIG. 10, communication between Pods indicated in the communication path information 52 is grasped as communication between the workloads executed on the corresponding Pod. A horizontal configuration relationship grasped by communication is represented by an edge (arrow) from a communication source that transmits a process request to a communication destination that receives the process request. A communication path in which edges of the same line type are coupled constitutes one communication path.

The example in FIG. 10 illustrates three communication paths. A first communication path is a communication path along which a process request is transmitted from the workload 87 to the workload 86. The first communication path is indicated by an edge of a one-dot broken line. A second communication path is a communication path along which a process request is transmitted from the workload 81 to the workload 88, by way of the workload 82 and the workload 86. The second communication path is indicated by an edge of a broken line. A third communication path is a communication path along which a process request is transmitted from the workload 83 to the workload 88, by way of the workload 84, the workload 85, and the workload 86. The third communication path is indicated by an edge of a solid line. In the following description, the first communication path is referred to as “path 1”, the second communication path is referred to as “path 2”, and the third communication path is referred to as “path 3”.

It is assumed that a problem occurs in the operation system 30 having such a configuration. The occurrence of the problem is detected by the monitoring apparatus 41, and information indicating a problem location is transmitted from the monitoring apparatus 41 to the analysis apparatus 100. With the analysis apparatus 100, the candidate element specifying unit 120 grasps a configuration of the operation system 30 based on the configuration information 51 and the communication path information 52. By tracing a vertical configuration relationship or a horizontal configuration relationship with the detected problem location, the candidate element specifying unit 120 sets a reachable element as a candidate element that may be influenced by the problem.

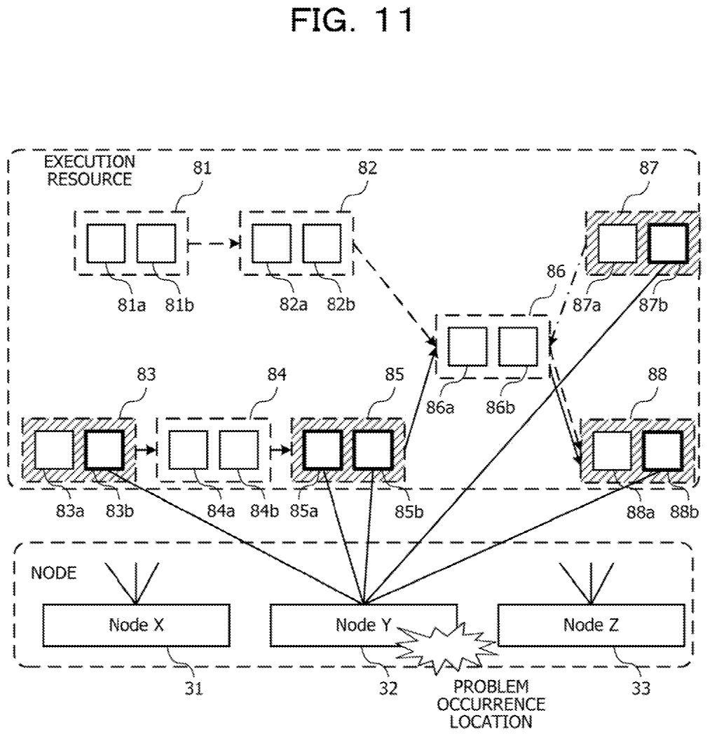

FIG. 11 is a diagram illustrating an example of candidate element specification based on a vertical configuration relationship. In the example in FIG. 11, a problem occurrence location is the node 32. In this case, the candidate element specifying unit 120 traces an edge indicating a vertical configuration relationship from the node 32, and detects five reachable Pods 83b, 85a, 85b, 87b, and 88b. The candidate element specifying unit 120 specifies the workloads 83, 85, 87, and 88 executed in any one of the detected Pods 83b, 85a, 85b, 87b, and 88b as candidate elements that may be an influence location. As illustrated in FIG. 11, the workloads 83, 85, 87, and 88 serving as the candidate elements are hatched.

After specifying the candidate element by tracing the vertical configuration relationship, the candidate element specifying unit 120 specifies a reachable workload as the candidate element by tracing a horizontal configuration relationship.

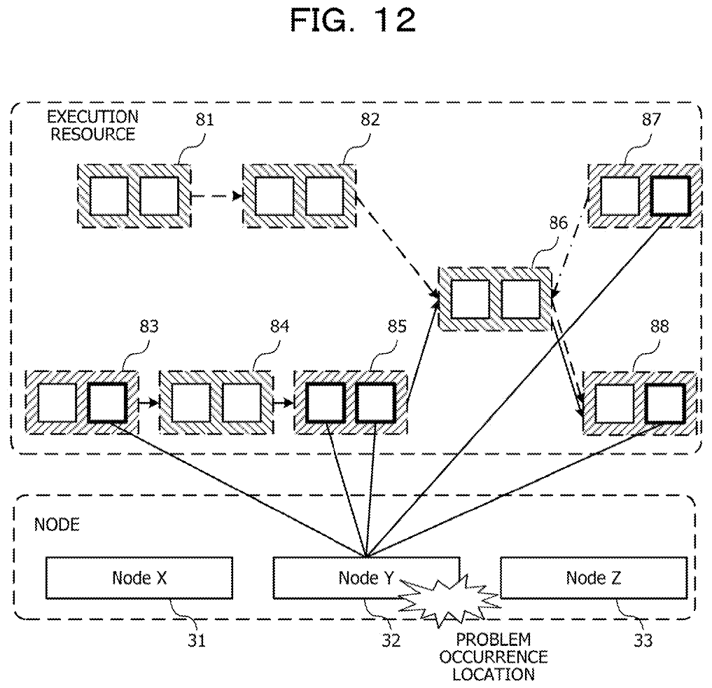

FIG. 12 is a diagram illustrating an example of candidate element specification based on a horizontal configuration relationship. For example, for each of the three communication paths indicated by the horizontal configuration relationship, the candidate element specifying unit 120 traces a communication path in a direction from the candidate element to a communication source, and adds a workload over the path to the candidate element. For example, when the second communication path (edge of broken line) is traced in a communication source direction from the workload 88 specified as the candidate element, the workloads 81, 82, and 86 are reached. Accordingly, these workloads 81, 82, and 86 are added to the candidate element. When the third communication path (edge of solid line) is traced in the communication source direction from the workload 88, the workloads 83 to 86 are reached. Among these workloads 83 to 86, the workload 84 which is not a candidate element yet is added to the candidate element.

In this manner, by tracing the configuration relationship, all the workloads 81 to 88 are specified as the candidate elements. When all of these workloads 81 to 88 are set as the influence locations, an influence range is too wide, and accuracy of being influenced by the problem for the workloads 81 to 88 within the influence range is decreased. Accordingly, the influence point calculation unit 130 performs an influence point calculation process, by using a deviation degree between metrics at a normal time and at a problem occurrence time.

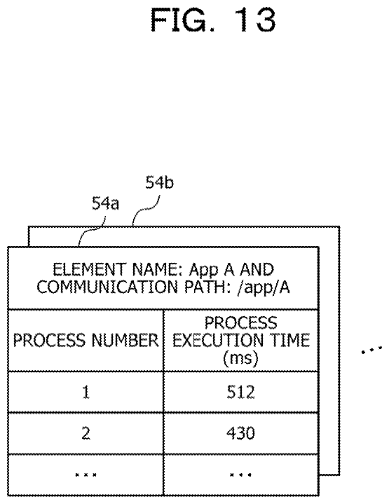

FIG. 13 is a diagram illustrating an example of a normal-time metric. From the monitoring apparatus 41, the influence point calculation unit 130 acquires normal-time metrics 54a, 54b, . . . for each communication path of each candidate element (workload). For example, in one normal-time metric 54a, a process execution time of each of a plurality of process requests via a communication path “/app/A” in a workload with an element name “App A” is set. When referring to the normal-time metric 54a, it is possible to obtain a statistical quantity such as an average value or a standard deviation of the process execution time for each communication path of the corresponding candidate element.

The normal-time metrics 54a, 54b, . . . are information obtained by the monitoring apparatus 41 observing for a predetermined period before detection of a problem. After the occurrence of the problem, the monitoring apparatus 41 records the observed process execution time as the problem-occurrence-time metric 55, in distinction from the normal-time metrics 54a, 54b, and . . . . In the same manner as the normal-time metrics 54a, 54b, and . . . , the monitoring apparatus 41 transmits the problem-occurrence-time metric 55 for each communication path of each candidate element to the analysis apparatus 100. Information included in the problem-occurrence-time metric 55 is the same type of information as the normal-time metrics 54a, 54b, . . . illustrated in FIG. 13.

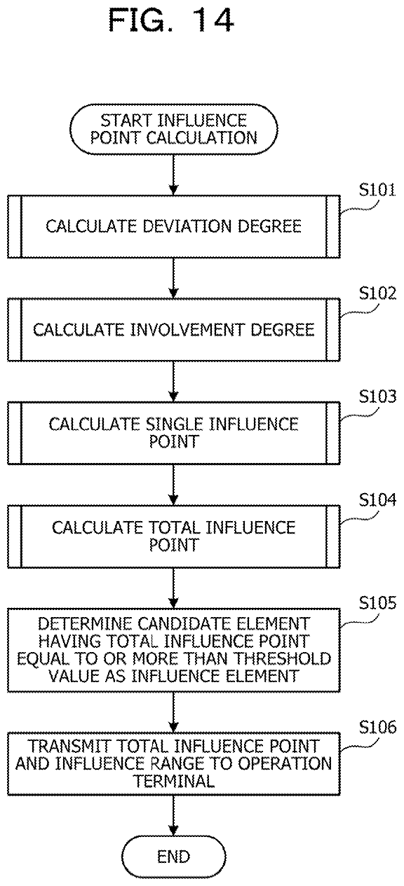

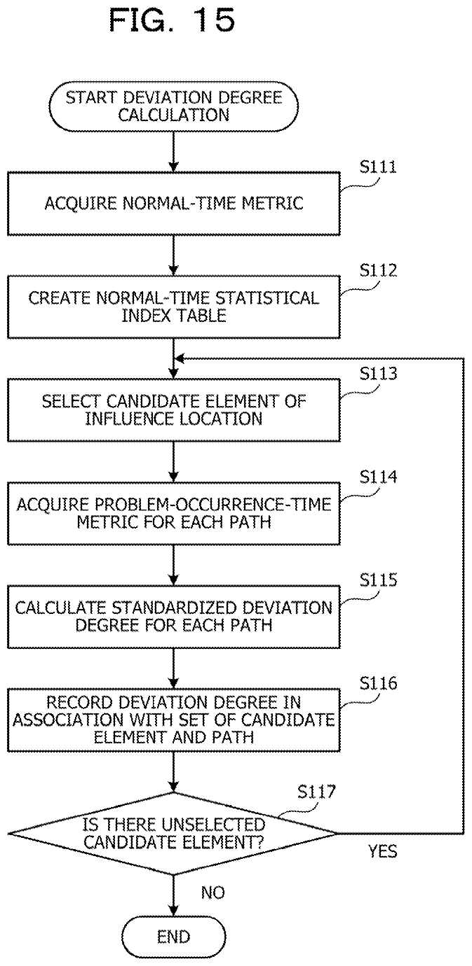

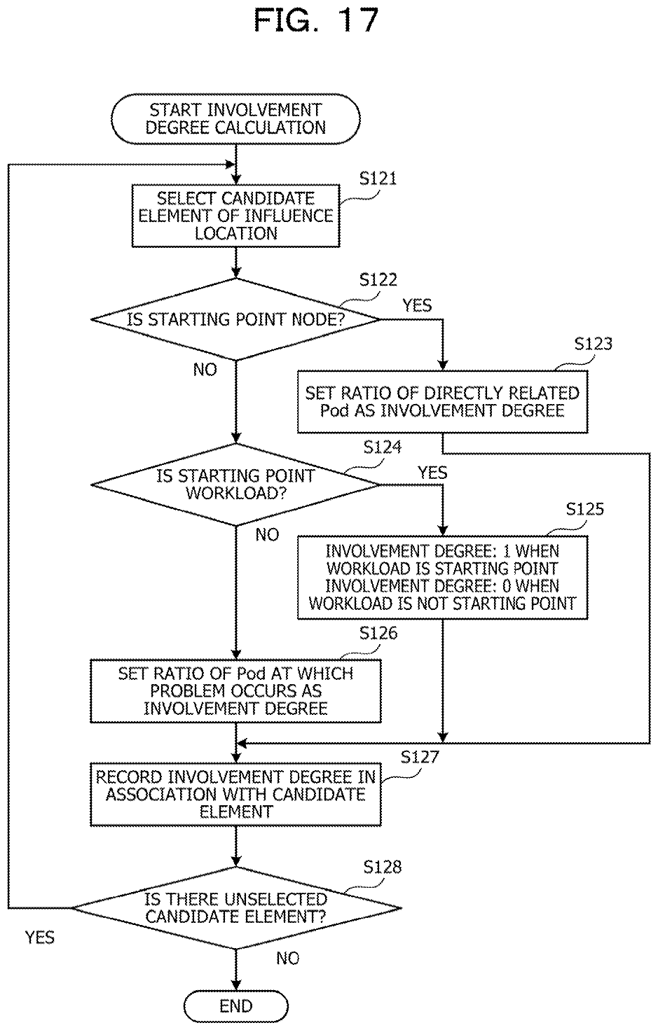

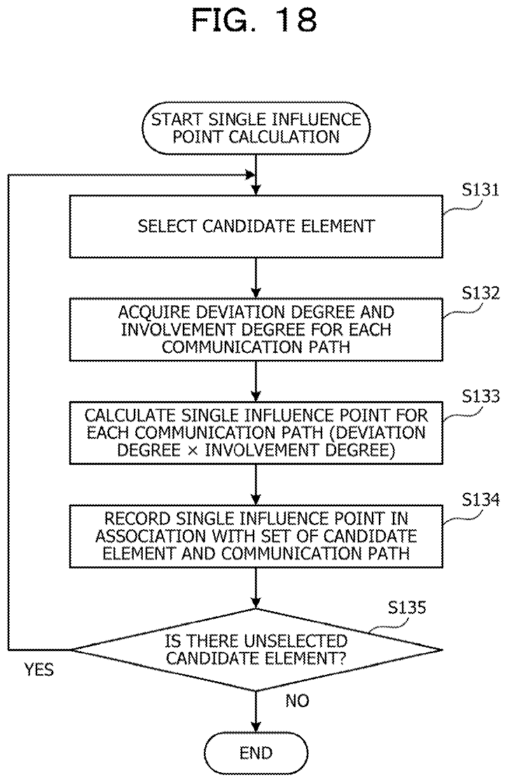

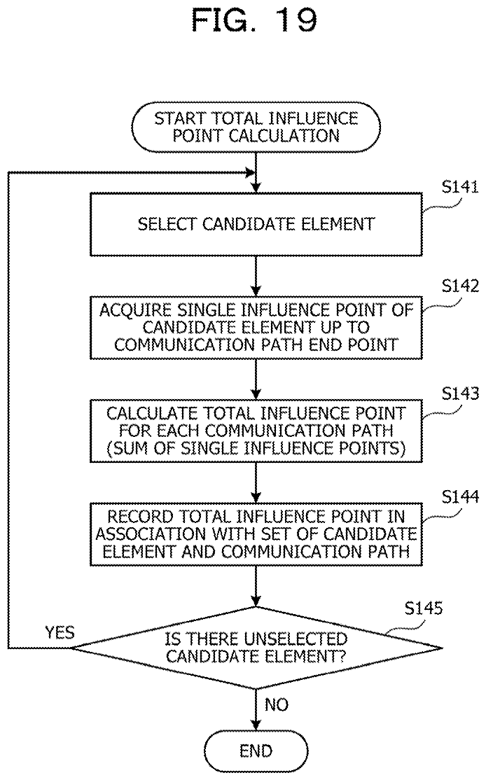

FIG. 14 is a flowchart illustrating an example of a procedure of an influence point calculation process. Hereinafter, the processes illustrated in FIG. 14 will be described in an order of step numbers.

[STEP S101] The influence point calculation unit 130 performs a deviation degree calculation process of a metric for each communication path of each candidate element. Details of the deviation degree calculation process will be described below (refer to FIG. 15).

[STEP S102] Based on the configuration information 51 of a system, the influence point calculation unit 130 performs an involvement degree calculation process for each candidate element. Details of the involvement degree calculation process will be described below (refer to FIG. 17).

[STEP S103] The influence point calculation unit 130 performs a single influence point calculation process. A single influence point for each candidate element is obtained by the single influence point calculation process. The single influence point is a value calculated from a deviation degree and an involvement degree for each candidate element. A deviation degree or an involvement degree of another candidate element having a horizontal configuration relationship with the candidate element is not added to the single influence point of each candidate element. Details of the single influence point calculation process will be described below (refer to FIG. 18).

[STEP S104] The influence point calculation unit 130 performs a total influence point calculation process. A total influence point is a value in consideration of a single influence point of the another candidate element having the horizontal configuration relationship. Details of the total influence point calculation process will be described below (refer to FIG. 19).

[STEP S105] The influence point calculation unit 130 determines a candidate element having a total influence point equal to or more than a threshold value as an influence element. The influence point calculation unit 130 sets a set of the influence elements as an influence range.

[STEP S106] The influence point calculation unit 130 transmits information indicating the total influence point and the influence range of each candidate element to the operation terminal 42.

In this manner, the influence range determined in accordance with the total influence point of each candidate element is notified to the operator. Hereinafter, details of each process in steps S101 to S104 will be described with reference to FIGS. 15 to 19.

FIG. 15 is a flowchart illustrating an example of a procedure of a deviation degree calculation process. Hereinafter, the processes illustrated in FIG. 15 will be described in an order of step numbers.

[STEP S111] The influence point calculation unit 130 acquires the normal-time metrics 54 of each candidate element, from the monitoring apparatus 41.

[STEP S112] The influence point calculation unit 130 analyzes the normal-time metric 54, and creates a normal-time statistical index table. The normal-time statistical index table is a data table in which statistical information for each communication path for each candidate element is summarized.

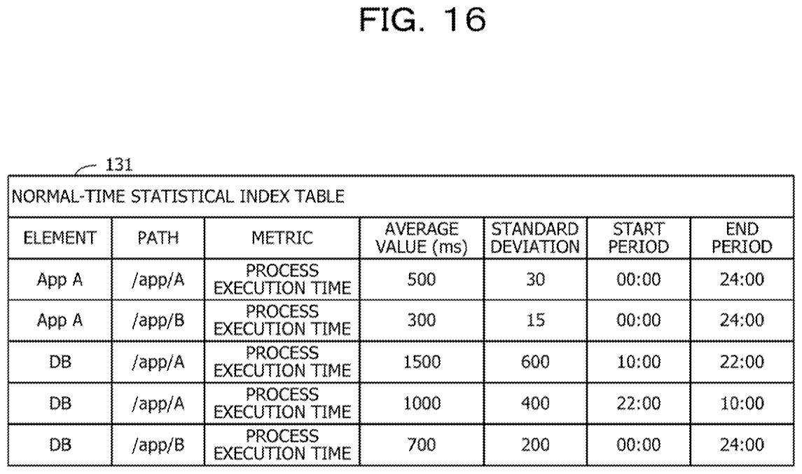

FIG. 16 illustrates an example of a normal-time statistical index table. A normal-time statistical index table 131 includes fields of an element, a path, a metric, an average value, a standard deviation, a period start, and a period end. An element name of a candidate element is set in the field of the element. Information indicating a communication path included in the candidate element over the path is set in the field of the path. Information indicating a type of the metric acquired in association with a set of the candidate element and the communication path is set in the field of the metric. An average value of values of the metric in the set of the candidate element and the communication path is set in the field of the average value. A standard deviation of the values of the metric in the set of the candidate element and the communication path is set in the field of the standard deviation. A start time of a period in which the metric is observed is set in the field of the period start. An end time of the period in which the metric is observed is set in the field of the period end.

A standard deviation σ of a metric at a normal time may be obtained by following Equation (1).

$$σ = \sqrt{\frac{1}{n} {\sum }_{n = 1}^{n} {( {x}_{i} - μ )}^{2}} \qquad ( 1 )$$

In Equation (1), n is the number of samples. xᵢ is i-th actually measured data of metrics collected at the normal time (i is an integer equal to or more than 1 and equal to or less than n). μ is an average value of metrics.

Hereinafter, the description is returned to FIG. 15.

[STEP S113] Among the candidate elements of an influence location specified by the candidate element specifying unit 120, the influence point calculation unit 130 selects one unselected candidate element.

[STEP S114] The influence point calculation unit 130 acquires a problem-occurrence-time metric for each path for the selected candidate element, from the monitoring apparatus 41.

[STEP S115] For the selected candidate element, the influence point calculation unit 130 calculates a deviation degree for each path. For example, the influence point calculation unit 130 uses the average and the standard deviation of the metrics at the normal time to obtain a deviation degree Z standardized by following Equation (2).

$$Z = \vert \frac{X - μ}{σ} \vert \qquad ( 2 )$$

In Equation (2), X is actually measured data of the metric at a problem occurrence time. In a case where a plurality of pieces of actually measured data of the metric at the problem occurrence time may be acquired, for example, an average of the pieces of actually measured data may be set as X. In Equation (2), an absolute value of a value obtained by dividing a difference between the metric X at the problem occurrence time and the average value μ of the metrics at the normal time by the standard deviation σ of the metrics at the normal time is the deviation degree Z. In this case, standardization (may also be referred to as normalization) is performed such that the deviation degree Z is 1 in a case where the difference between the metric X at the problem occurrence time and the average value μ of the metrics at the normal-time is equal to the standard deviation σ.

By calculating the standardized deviation degree Z, it is also easy to obtain the deviation degree by combining a plurality of metrics. For example, in a case where the plurality of metrics are used, the influence point calculation unit 130 may set an average of standardized deviation degrees of the individual metrics as a deviation degree of the corresponding path of the selected candidate element. The influence point calculation unit 130 may set the maximum value among the standardized deviation degrees of each of the plurality of metrics as the deviation degree of the corresponding path of the selected candidate element.

In a case where a statistical index (average value and standard deviation) of the metric at the normal time is aggregated for each time zone, the deviation degree may be calculated based on the statistical index of the metric at the normal time in the time zone including a time at which the problem occurs. For example, when the occurrence time of the problem is “12:00”, the influence point calculation unit 130 calculates the deviation degree of the metric at the normal time with a period start “10:00” and a period end “22:00” (measurement period from 10:00 to 22:00).

[STEP S116] The influence point calculation unit 130 records the calculated deviation degree in the memory 102 or the like, in association with a set of the selected candidate element and the path.

[STEP S117] The influence point calculation unit 130 determines whether or not there is an unselected candidate element. When there is the unselected candidate element, the influence point calculation unit 130 shifts the process to step S113. When all the candidate elements are selected, the influence point calculation unit 130 ends the deviation degree calculation process.

In this manner, the deviation degree for each path is obtained for each candidate element. Next, the involvement degree calculation process will be described in detail.

FIG. 17 is a flowchart illustrating an example of a procedure of the involvement degree calculation process. Hereinafter, the processes illustrated in FIG. 17 will be described in an order of step numbers.

[STEP S121] Among the candidate elements of the influence location, the influence point calculation unit 130 selects one unselected candidate element.

[STEP S122] The influence point calculation unit 130 determines whether or not a problem occurrence location (a starting point of an influence range) is a node. When the starting point is a node, the influence point calculation unit 130 shifts the process to step S123. When the starting point is not a node, the influence point calculation unit 130 shifts the process to step S124.

[STEP S123] Among Pods in the selected candidate element (workload), the influence point calculation unit 130 sets a ratio of Pod having a direct relationship (vertical configuration relationship) with the node at the starting point, as the involvement degree of the candidate element. After that, the influence point calculation unit 130 shifts the process to step S127.

[STEP S124] The influence point calculation unit 130 determines whether or not the starting point of the influence range is a workload. When the starting point is a workload, the influence point calculation unit 130 shifts the process to step S125. When the starting point is not a workload, the influence point calculation unit 130 shifts the process to step S126.

[STEP S125] When the selected candidate element is a starting point, the influence point calculation unit 130 sets the involvement degree of the candidate element to “1”. When the selected candidate element is not a starting point, the influence point calculation unit 130 sets the involvement degree to “0”. After that, the influence point calculation unit 130 shifts the process to step S127.

[STEP S126] Among Pods in the selected candidate element, the influence point calculation unit 130 sets a ratio of Pod at which the problem occurs as the involvement degree of the candidate element.

[STEP S127] The influence point calculation unit 130 records the calculated involvement degree in the memory 102 or the like, in association with the selected candidate element.

[STEP S128] The influence point calculation unit 130 determines whether or not there is an unselected candidate element. When there is the unselected candidate element, the influence point calculation unit 130 shifts the process to step S121. When all the candidate elements are selected, the influence point calculation unit 130 ends the involvement degree calculation process.

In this manner, the involvement degree of each candidate element is calculated. A single influence point for each path of each candidate element is calculated, based on the deviation degree and the involvement degree.

FIG. 18 is a flowchart illustrating an example of a procedure of a single influence point calculation process. Hereinafter, the processes illustrated in FIG. 18 will be described in an order of step numbers.

[STEP S131] Among the candidate elements of the influence location, the influence point calculation unit 130 selects one unselected candidate element.

[STEP S132] For each communication path for the selected candidate element, the influence point calculation unit 130 acquires the deviation degree and the involvement degree of the candidate element.

[STEP S133] The influence point calculation unit 130 calculates a single influence point for each communication path of the selected candidate element. The single influence point is, for example, “deviation degree×involvement degree”.

[STEP S134] The influence point calculation unit 130 records the calculated single influence point in the memory 102 or the like, in association with a set of the candidate element and the communication path.

[STEP S135] The influence point calculation unit 130 determines whether or not there is an unselected candidate element. When there is the unselected candidate element, the influence point calculation unit 130 shifts the process to step S131. When all the candidate elements are selected, the influence point calculation unit 130 ends the single influence point calculation process.

In this manner, the single influence point for each path of each candidate element is calculated. After that, a total influence point is calculated by using the calculated single influence point.

FIG. 19 is a flowchart illustrating an example of a procedure of a total influence point calculation process. Hereinafter, the processes illustrated in FIG. 19 will be described in an order of step numbers.

[STEP S141] Among the candidate elements of the influence location, the influence point calculation unit 130 selects one unselected candidate element.

[STEP S142] For each communication path passing through the selected candidate element, the influence point calculation unit 130 acquires a single influence point of each candidate element from the selected candidate element to an end.

[STEP S143] The influence point calculation unit 130 calculates a total influence point for each communication path of the selected candidate element. For example, the influence point calculation unit 130 sums up the single influence points of each candidate element from the selected candidate element to the end of the communication path for each communication path, and sets a total value as the total influence point.

[STEP S144] The influence point calculation unit 130 records the calculated total influence point in the memory 102 or the like, in association with a set of the candidate element and the communication path.

[STEP S145] The influence point calculation unit 130 determines whether or not there is an unselected candidate element. When there is the unselected candidate element, the influence point calculation unit 130 shifts the process to step S141. When all the candidate elements are selected, the influence point calculation unit 130 ends the total influence point calculation process.

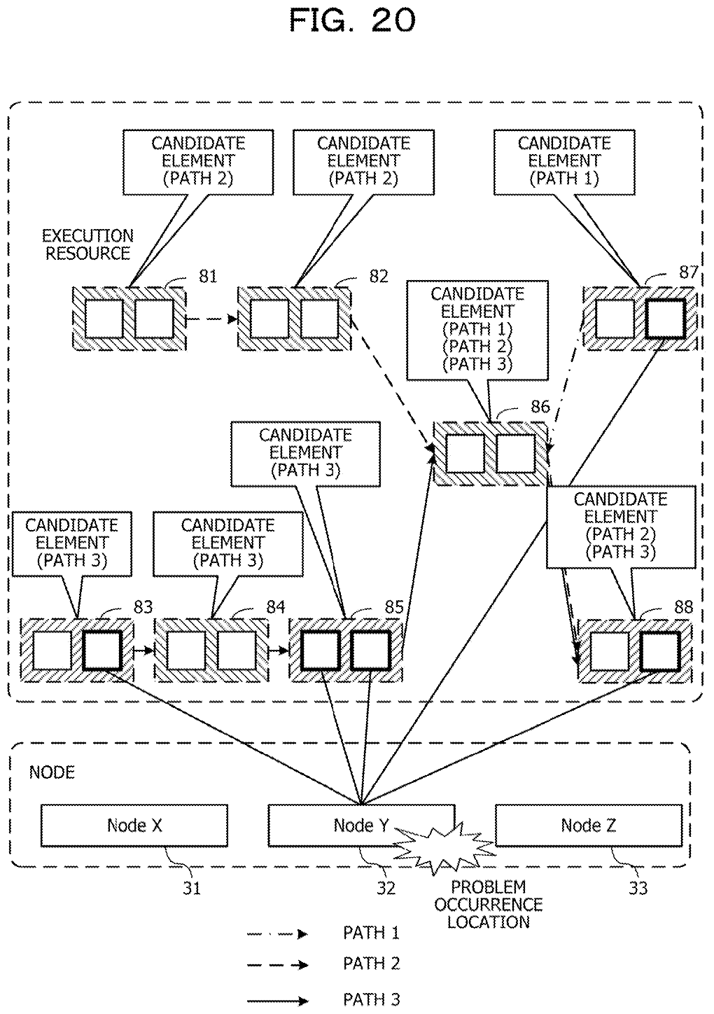

The candidate element of which the total influence point calculated in this manner is equal to or more than a predetermined value is included in an influence range as an influence element. Hereinafter, an example of determining the influence range will be specifically described with reference to FIGS. 20 to 24.

FIG. 20 is a diagram illustrating an example of a specification result of a candidate element of an influence location. FIG. 20 illustrates an example of a case where a problem occurs in the node 32. By tracing a vertical configuration relationship and a horizontal configuration relationship from the node 32, all the workloads 81 to 88 are reached. Therefore, all the workloads 81 to 88 are specified as candidate elements. There are three communication paths indicating the horizontal configuration relationship. Regarding a first communication path “path 1”, the workload 87 is a communication source and the workload 86 is a communication destination. A second communication path “path 2” is a communication path having the workload 81 as a first communication source and the workload 88 as an end, by way of the workload 82 and the workload 86. A third communication path “path 3” is a communication path having the workload 83 as a first communication source and the workload 88 as an end, by way of the workload 84, the workload 85, and the workload 86.

In this case, the workload 86 is in the three communication paths. The workload 88 is in the two communication paths. Since the communication path “path 1” of the workload 86 is not received from other elements (nodes, workloads, or the like) via the communication path, the communication path “path 1” of the workload 86 is excluded from a calculation target of the total influence point. After the candidate elements are specified, the deviation degree for each communication path is calculated for each candidate element.

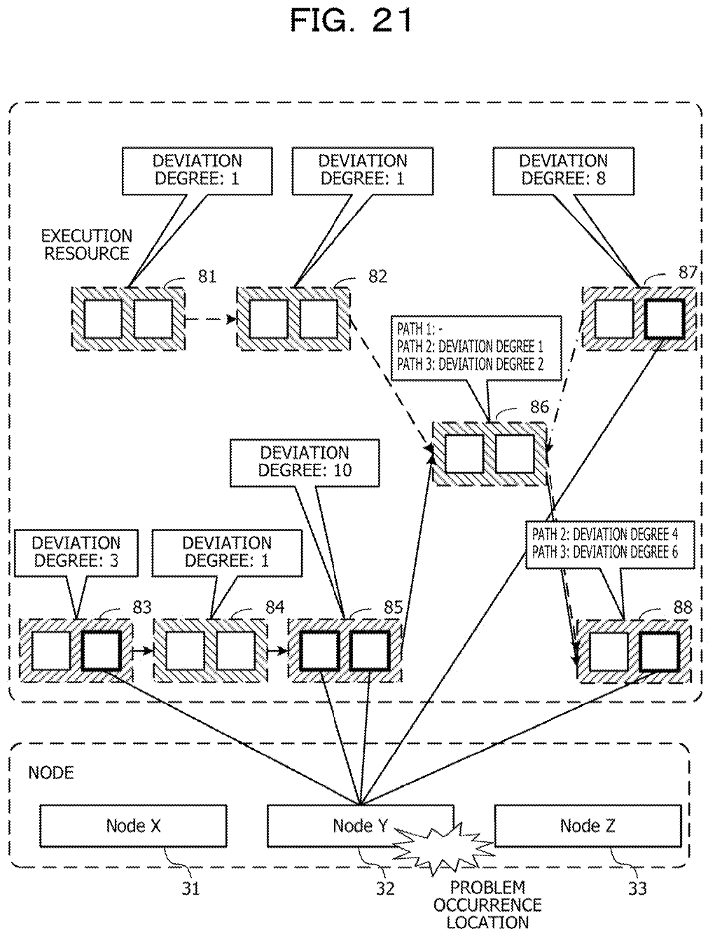

FIG. 21 is a diagram illustrating an example of a calculation result of a deviation degree. With the example illustrated in FIG. 21, a deviation degree for the communication path “path 2” of the workload 81 is “1”. A deviation degree for the communication path “path 2” of the workload 82 is “1”. A deviation degree for the communication path “path 3” of the workload 83 is “3”. A deviation degree for the communication path “path 3” of the workload 84 is “1”. A deviation degree for the communication path “path 3” of the workload 85 is “10”. A deviation degree for the communication path “path 2” of the workload 86 is “1”. A deviation degree for the communication path “path 3” of the workload 86 is “2”. A deviation degree for the communication path “path 1” of the workload 87 is “8”. A deviation degree for the communication path “path 2” of the workload 88 is “4”. A deviation degree for the communication path “path 3” of the workload 88 is “6”.

After the deviation degree is obtained, an involvement degree for each candidate element is calculated.

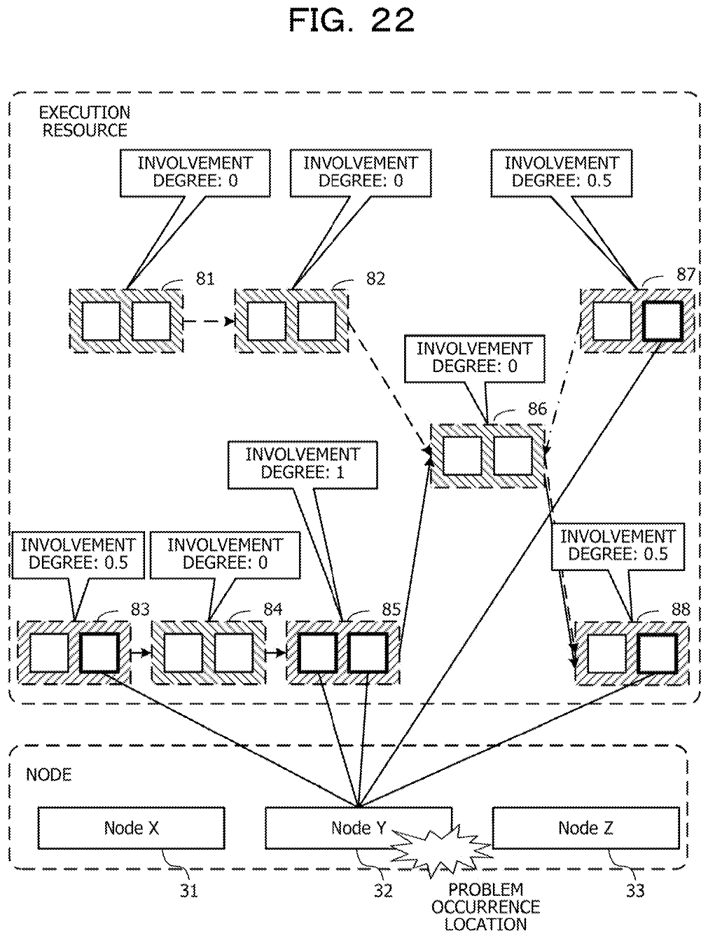

FIG. 22 is a diagram illustrating an example of a calculation result of an involvement degree. In the example illustrated in FIG. 22, a problem occurrence location is the node 32, and a starting point of an influence range is the node 32. Since Pod in the workload 81 does not have a vertical configuration relationship with the starting point, an involvement degree of the workload 81 is “0”. Since Pod in the workload 82 does not have a vertical configuration relationship with the starting point, an involvement degree of the workload 82 is also “0”. Since one of two Pods in the workload 83 has a vertical configuration relationship with the starting point, an involvement degree of the workload 83 is “0.5”. Since Pod in the workload 84 does not have a vertical configuration relationship with the starting point, an involvement degree of the workload 84 is “0”. Since both of two Pods in the workload 85 have a vertical configuration relationship with the starting point, an involvement degree of the workload 85 is “1”. Since Pod in the workload 86 does not have a vertical configuration relationship with the starting point, an involvement degree of the workload 86 is “0”. Since one of two Pods in the workload 87 has a vertical configuration relationship with the starting point, an involvement degree of the workload 87 is “0.5”. Since one of two Pods in the workload 88 has a vertical configuration relationship with the starting point, an involvement degree of the workload 88 is also “0.5”.

After the deviation degree and the involvement degree are calculated, a single influence point is calculated next.

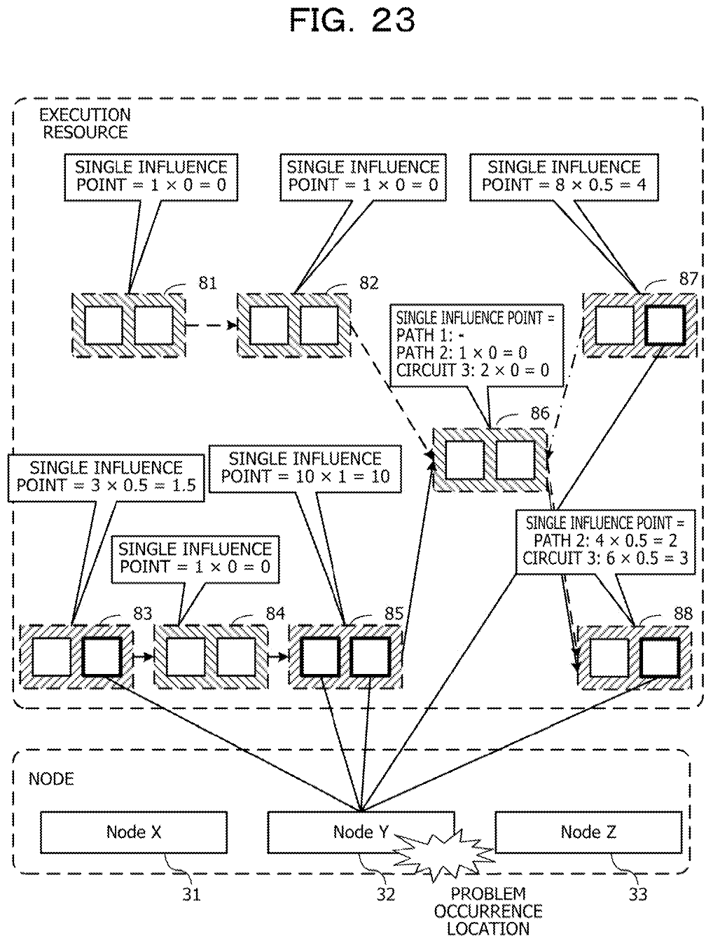

FIG. 23 is a diagram illustrating an example of a calculation result of a single influence point. Since the workload 81 has a deviation degree of “1” and an involvement degree of “0”, a single influence point is “0” (1×0). Since the workload 82 has a deviation degree of “1” and an involvement degree of “0”, a single influence point is “0” (1×0). Since the workload 83 has a deviation degree of “3” and an involvement degree of “0.5”, a single influence point is “1.5” (3×0.5). Since the workload 84 has a deviation degree of “1” and an involvement degree of “0”, a single influence point is “0” (1×0). Since the workload 85 has a deviation degree of “10” and an involvement degree of “1”, a single influence point is “10” (10×1). Since a deviation degree is “1” and an involvement degree is “0” for the communication path “path 2” of the workload 86, a single influence point of the communication path “path 2” is “0” (1×0). Since a deviation degree is “2” and an involvement degree is “0” for the communication path “path 3” of the workload 86, a single influence point of the communication path “path 3” is “0” (2×0). Since the workload 87 has a deviation degree of “8” and an involvement degree of “0.5”, a single influence point is “4” (8×0.5). Since a deviation degree is “4” and an involvement degree is “0.5” for the communication path “path 2” of the workload 88, a single influence point of the communication path “path 2” is “2” (4×0.5). Since a deviation degree is “6” and an involvement degree is “0.5” for the communication path “path 3” of the workload 88, a single influence point of the communication path “path 3” is “3” (6×0.5).

A total influence point is calculated based on the single influence points calculated in this manner.

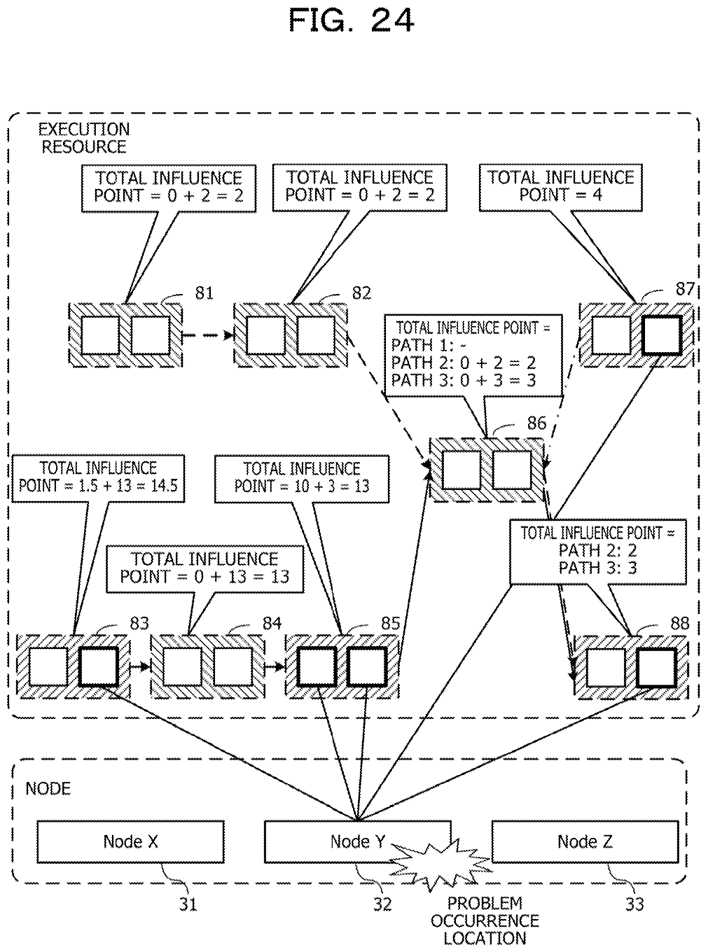

FIG. 24 is a diagram illustrating an example of a calculation result of a total influence point. A single influence point of the workload 81 is “0”, and a sum of single influence points from a communication destination of the workload 81 to an end of the communication path “path 2” is “2”. Accordingly, a total influence point of the workload 81 is “2” (0+2).

A single influence point of the workload 82 is “0”, and a sum of single influence points from a communication destination of the workload 82 to an end of the communication path “path 2” is “2”. Accordingly, a total influence point of the workload 82 is “2” (0+2).

A single influence point of the workload 83 is “1.5”, and a sum of single influence points from a communication destination of the workload 83 to an end of the communication path “path 3” is “13”. Accordingly, a total influence point of the workload 83 is “14.5” (1.5+13).

A single influence point of the workload 84 is “0”, and a sum of single influence points from a communication destination of the workload 84 to an end of the communication path “path 3” is “13”. Accordingly, a total influence point of the workload 84 is “13” (0+13).

A single influence point of the workload 85 is “10”, and a sum of single influence points from a communication destination of the workload 85 to an end of the communication path “path 3” is “3”. Accordingly, a total influence point of the workload 85 is “13” (10+3).

A single influence point of the communication path “path 2” of the workload 86 is “0”, and a sum of single influence points from a communication destination of the workload 86 to an end of the communication path “path 2” is “2”. Accordingly, a total influence point of the communication path “path 2” of the workload 86 is “2” (0+2). A single influence point of the communication path “path 3” of the workload 86 is “0”, and a sum of single influence points from a communication destination of the workload 86 to an end of the communication path “path 3” is “3”. Accordingly, a total influence point of the communication path “path 3” of the workload 86 is “3” (0+3).

A single influence point of the workload 87 is “4”, and the workload 86 of a communication destination of the communication path “1” is not a calculation target of a total influence point for the communication path “1”. Accordingly, a total influence point of the workload 87 is “4”, which is the same as the single influence point.

For the communication path “path 2” of the workload 88, a single influence point of the workload 88 is “2”, and a communication destination of the communication path “path 2” does not exist. Accordingly, a total influence point of the communication path “path 2” of the workload 88 is “2”, which is the same as the single influence point. For the communication path “path 3” of the workload 88, a single influence point of the workload 88 is “3”, and a communication destination of the communication path “path 3” does not exist. Accordingly, a total influence point of the communication path “path 3” of the workload 88 is “3”, which is the same as the single influence point.

A workload with which the total influence point calculated in this manner is equal to or more than a predetermined threshold value is determined to be an influence element influenced by the problem. For example, in a case where the threshold value is “10”, the three workloads 83, 84, and 85 are the influence elements. A range including these workloads 83, 84, and 85 is an influence range of the problem. The influence point calculation unit 130 transmits information indicating the influence range and the total influence point of each workload to the operation terminal 42. An influence range display screen indicating the influence range of the problem, for example, is displayed on the operation terminal 42 which receives the influence range and the total influence point.

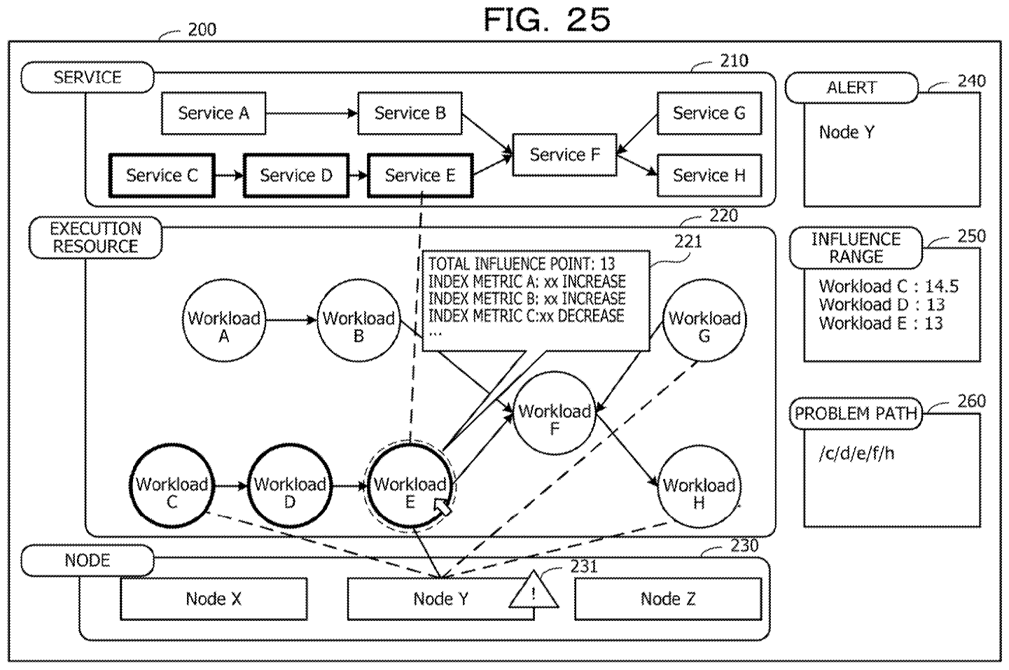

FIG. 25 is a diagram illustrating an example of an influence range screen. An influence range display screen 200 includes a service display unit 210, an execution resource display unit 220, a node display unit 230, an alert display unit 240, an influence range display unit 250, and a problem path display unit 260.

The service display unit 210 illustrates a relationship between services provided by the operation system 30. A service corresponding to a workload within an influence range in the service display unit 210 is highlighted. The execution resource display unit 220 illustrates a workload and a relationship between workloads. A workload within an influence range in the execution resource display unit 220 is highlighted. A node in the operation system 30 is displayed on the node display unit 230.

A mark 231 indicating a problem occurrence location is displayed on a workload or a node that is the problem occurrence location in the execution resource display unit 220 or the node display unit 230. In the example illustrated in FIG. 25, “Node Y” is the problem occurrence location, and the mark 231 is displayed over an object indicating “Node Y”.

Information indicating the problem occurrence location is displayed on the alert display unit 240. The influence range display unit 250 displays information indicating a workload included in the influence range. A total influence point of the workload is given to each workload in the influence range display unit 250. The problem path display unit 260 displays information indicating a communication path having a total influence point equal to or more than a predetermined threshold value in the workload included in the influence range.

By referring to the influence range display screen 200, the operator may grasp the problem occurrence location and the influence range of the problem. For example, when the operator selects a workload, which is an influence element, by using a mouse cursor or the like, an influence detail screen 221 indicating influence contents on the corresponding workload is displayed in a pop-up manner. For example, the influence detail screen 221 displays a total influence point of the selected workload, a difference in metric at a normal time and a problem occurrence time, and the like. For example, whether a value of a metric is increased or decreased at the normal time as compared at the problem occurrence time is displayed for each metric on the influence detail screen 221. A difference between the values of the metric at the normal time and at the problem occurrence time may be displayed on the influence detail screen 221.

Although the example illustrated in FIGS. 20 to 25 is a case where the problem occurrence location is a node, the problem occurrence location may be a workload or Pod. A method of determining an involvement degree in a case where the problem occurrence location is the workload or Pod is different from a method in a case where the problem occurrence location is the node.

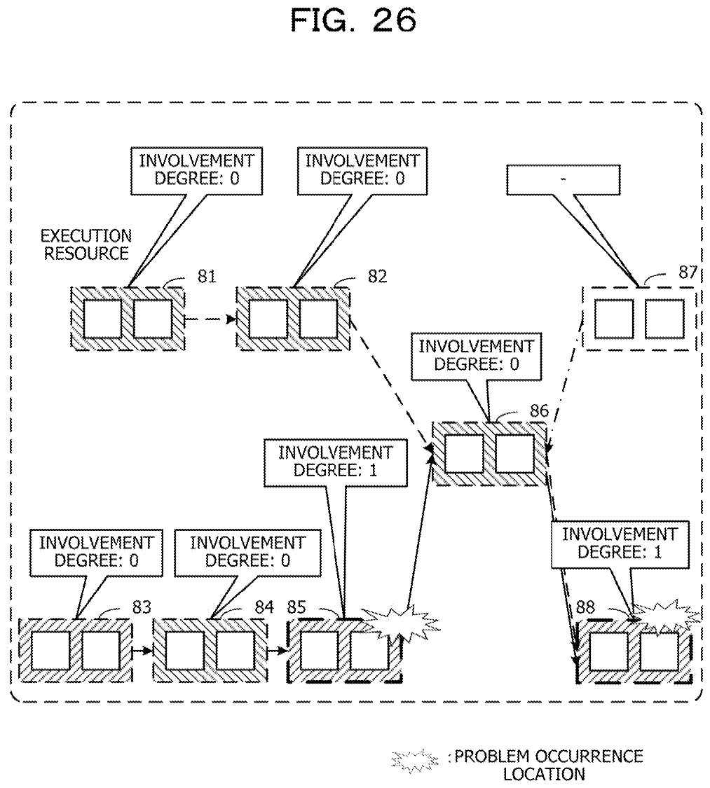

FIG. 26 is a diagram illustrating an example of a calculation result of an involvement degree in a case where a problem occurrence location is a workload. In the example illustrated in FIG. 26, the workload 85 and the workload 88 are problem occurrence locations. In this case, since the workload 88 is an end of the communication path “path 2” and the communication path “path 3”, the workloads 81 to 86, and 88 over the two communication paths serve as candidate elements of an influence range, and an involvement degree is calculated. On the other hand, since there is no problem occurrence location over the communication path “path 1”, the workload 87 related only to the communication path is not included in the candidate elements. Among the workloads 81 to 86, and 88 serving as the candidate elements, the involvement degree between the workload 85 and the workload 88 serving as the problem occurrence locations is “1”. The involvement degree of the other workloads 81 to 84, and 86 is “0”.

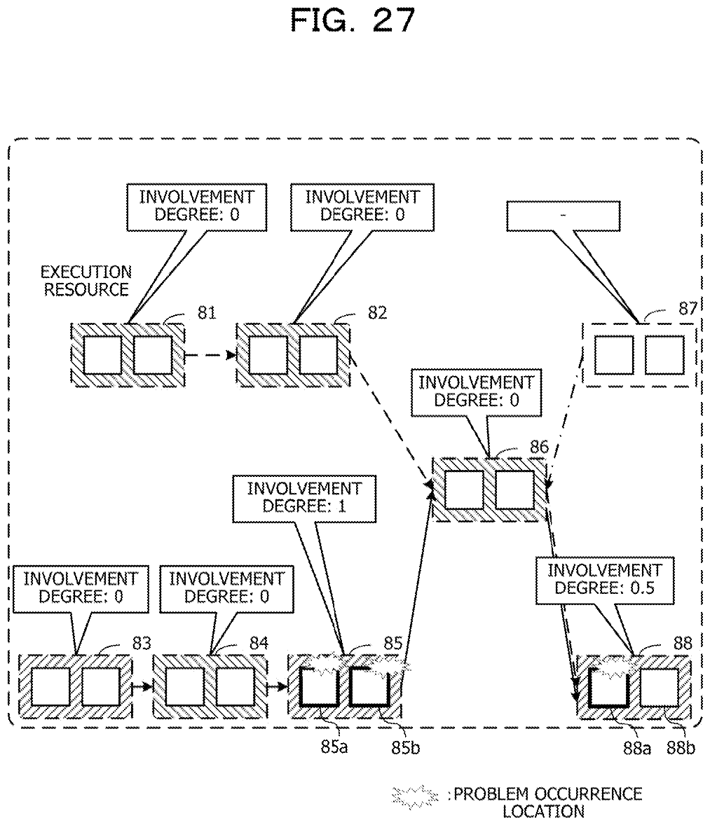

FIG. 27 is a diagram illustrating an example of a calculation result of an involvement degree in a case where a problem occurrence location is Pod. In the example illustrated in FIG. 27, two Pods 85a and 85b in the workload 85 and one Pod 88a in the workload 88 are problem occurrence locations. Also in this case, in the same manner as the example illustrated in FIG. 26, the workloads 81 to 86, and 88 serve as candidate elements of an influence range, and the workload 87 is not included in the candidate elements. For the workload 85, a ratio of the problem occurrence location to Pods 85a and 85b included in the workload 85 is “2/2”, and the involvement degree is “1”. For the workload 88, the ratio of the problem occurrence location to Pods 88a and 88b is “1/2”, and the involvement degree is “0.5”. The involvement degree of the other workloads 81 to 84, and 86, which are the candidate elements, is “0”.

As illustrated in FIGS. 26 and 27, in a case where a problem occurs in an entire workload, an involvement degree of the workload is “1”, and in a case where a problem occurs in Pod in the workload, a ratio of Pod having the problem in the workload is the involvement degree. Therefore, it is possible to increase the involvement degree for a workload having a higher ratio of Pod at which a problem occurs, and to correctly calculate the degree of influence of the problem on the workload over a communication path to which the workload is related.

### Other Embodiments

Although the monitoring apparatus 41 and the analysis apparatus 100 are described as separate apparatuses in the second embodiment, these apparatuses may be implemented by one apparatus.

Although the example of the case where the metric is a process execution time is described in the second embodiment, a metric which is usable for calculating a deviation degree is not limited to the process execution time.

Hereinbefore, the embodiments are exemplified, the configuration of each unit described in the embodiment may be replaced with another unit having the same function. Arbitrary another component or step may be added. Arbitrary two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an analysis program for causing a computer to execute a process comprising:
calculating, when a problem occurs in a monitoring target system, a deviation degree between a first measurement value which represents an execution state of a process in a period in which the problem does not occur and a second measurement value which represents the execution state of the process in a period in which the problem occurs, for each of a plurality of software elements executed in the monitoring target system;
calculating an involvement degree which indicates a degree of relevance to the problem, for each of the plurality of software elements, based on a relationship over a system configuration between an occurrence location of the problem and each of the plurality of software elements;
calculating a single influence point which indicates a degree of being individually influenced by the problem, for each of the plurality of software elements, based on the deviation degree and the involvement degree; and
calculating a total influence point which indicates a degree to which a first software element is influenced by the problem, based on a single influence point of the first software element and a single influence point of a second software element over a communication path of communication via a process by the first software element.

2. The non-transitory computer-readable recording medium according to claim 1,
wherein in the calculating of the total influence point, a software element which is a transmission destination of a process request in a communication path of the process request via the first software element is set as the second software element.

3. The non-transitory computer-readable recording medium according to claim 1,
wherein in the calculating of the total influence point, a sum of the single influence point of the first software element and the single influence point of the second software element is set as the total influence point.

4. The non-transitory computer-readable recording medium according to claim 1,
wherein in the calculating of the involvement degree, the involvement degree of a target software element of which the involvement degree is to be calculated is calculated, based on a ratio of a virtual software execution environment which operates over a node which is the occurrence location of the problem to virtual software execution environments at which the target software element is executed.

5. The non-transitory computer-readable recording medium according to claim 1,
wherein in the calculating of the involvement degree, the involvement degree of a software element which is the occurrence location of the problem is set to be higher than the involvement degree of a software element which is not the occurrence location of the problem.

6. The non-transitory computer-readable recording medium according to claim 1,
wherein in the calculating of the involvement degree, the involvement degree of a target software element of which the involvement degree is to be calculated is calculated, based on a ratio of a management unit which is the occurrence location of the problem to a plurality of management units for managing a virtual software execution environment at which the target software element is executed.

7. The non-transitory computer-readable recording medium according to claim 1,
wherein in the calculating of the deviation degree, the deviation degree for each communication path for each of the plurality of software elements is calculated,
in the calculating of the single influence point, the single influence point for each communication path for each of the plurality of software elements is calculated, and
in the calculating of the total influence point, the total influence point for each communication path for each of the plurality of software elements is calculated.

8. The non-transitory computer-readable recording medium according to claim 1,
wherein the analysis program causes the computer to further execute a process of determining that the first software element is within an influence range of the problem in a case where the total influence point of the first software element is equal to or more than a predetermined value.

9. An analysis method comprising:
calculating, when a problem occurs in a monitoring target system, a deviation degree between a first measurement value which represents an execution state of a process in a period in which the problem does not occur and a second measurement value which represents the execution state of the process in a period in which the problem occurs, for each of a plurality of software elements executed in the monitoring target system;
calculating an involvement degree which indicates a degree of relevance to the problem, for each of the plurality of software elements, based on a relationship over a system configuration between an occurrence location of the problem and each of the plurality of software elements;
calculating a single influence point which indicates a degree of being individually influenced by the problem, for each of the plurality of software elements, based on the deviation degree and the involvement degree; and
calculating a total influence point which indicates a degree to which a first software element is influenced by the problem, based on a single influence point of the first software element and a single influence point of a second software element over a communication path of communication via a process by the first software element.

10. An information processing system comprising:
a memory; and
a processor coupled to the memory and configured to:
calculate, when a problem occurs in a monitoring target system, a deviation degree between a first measurement value which represents an execution state of a process in a period in which the problem does not occur and a second measurement value which represents the execution state of the process in a period in which the problem occurs, for each of a plurality of software elements executed in the monitoring target system;
calculate an involvement degree which indicates a degree of relevance to the problem, for each of the plurality of software elements, based on a relationship over a system configuration between an occurrence location of the problem and each of the plurality of software elements;
calculate a single influence point which indicates a degree of being individually influenced by the problem, for each of the plurality of software elements, based on the deviation degree and the involvement degree; and
calculate a total influence point which indicates a degree to which a first software element is influenced by the problem, based on a single influence point of the first software element and a single influence point of a second software element over a communication path of communication via a process by the first software element.
